(19) United States
(12) Patent Application Publication
(10) Pub. No.: US 2013/0179371 A1
(43) Pub. Date: Jul. 11, 2013

(54) SCHEDULING COMPUTING JOBS BASED ON VALUE

(71) Applicants: Navendu Jain, Bellevue, WA (US); Ishai Menache, Redmond, WA (US); Joseph Naor, Haifa (IL); Jonathan Yaniv, Haifa (IL)

(72) Inventors: Navendu Jain, Bellevue, WA (US); Ishai Menache, Redmond, WA (US); Joseph Naor, Haifa (IL); Jonathan Yaniv, Haifa (IL)

(73) Assignee: MICROSOFT CORPORATION, Redmond, WA (US)

(21) Appl. No.: 13/344,596

(22) Filed: Jan. 5, 2012

(51) Int. Cl. G06Q 40/00; G06F 9/46

(52) U.S. Cl. 705/400; 718/102

(57) ABSTRACT

A plurality of requests for execution of computing jobs on one or more devices that include a plurality of computing resources may be obtained, the one or more devices configured to flexibly allocate the plurality of computing resources, each of the computing jobs including job completion values representing a worth to a respective user that is associated with execution completion times of each respective computing job. The computing resources may be scheduled based on the job completion values associated with each respective computing job.

### BACKGROUND

Cloud computing environments may provide computation platforms, in which computing resources (e.g., virtual machines, storage capacity) may be rented to end-users under a utility pricing model. For example, a provider may offer a pay-as-you-go service, in which users may be charged a fixed price per unit resource per hour. For example, the provider may offer the service as a network cloud service, for example, via the Internet. Thus, the users may obtain access to computing resources, without substantial investments in machines, development and maintenance personnel, and other computing resources, for supporting personal or departmental systems.

Many different types of users may desire access to such cloud computing services. For example, a researcher may desire access to a substantial aggregate of computing resources to run batch jobs that may execute as background applications (e.g., running simulations and generating statistical results of various configurations of models), and the researcher may have sufficient time in his/her schedule to allow for a substantial time interval between submission of the researcher's jobs and receipt of results of the jobs' execution. As another example, a financial advisor may similarly desire access to a substantial aggregate of computing resources to run batch jobs, to determine which stocks to sell/buy at the opening of the stock market on the day following their job submission. Thus, if the financial advisor receives results two days late, the results may be worth nothing (to the financial advisor) at that point in time.

### SUMMARY

According to one general aspect, a plurality of requests for execution of computing jobs on one or more devices that include a plurality of computing resources may be obtained, the one or more devices configured to flexibly allocate the plurality of computing resources, each of the computing jobs including job completion values representing a worth to a respective user that is associated with execution completion times of each respective computing job. The computing resources may be scheduled based on the job completion values associated with each respective computing job.

According to another aspect, a plurality of job objects may be obtained, each of the job objects including a job valuation function representing a worth to a respective user that is associated with execution completion times of respective computing jobs that are associated with each respective job object. An optimal fractional solution associated with a relaxed linear program (LP) for scheduling computing resources may be determined for execution of the computing jobs associated with each respective job object, based on a bounded scheduling problem based on maximizing an objective that is based on the respective job valuation functions. A decomposition of the optimal fractional solution that includes a plurality of solutions may be determined, each solution determining an allocation of the computing resources. The computing resources may be scheduled based on the decomposition.

According to another aspect, a computer program product tangibly embodied on a computer-readable storage medium may include executable code that may cause at least one data processing apparatus to obtain a plurality of job objects, each of the job objects including a job deadline valuation function representing a worth to a respective user that is associated with execution completion times of respective computing jobs associated with each respective job object. Further, the at least one data processing apparatus may determine a basic optimal fractional solution associated with a relaxed linear program (LP) for scheduling computing resources for execution of the respective computing jobs associated with each respective job object, based on a bounded scheduling problem based on maximizing an objective that is based on the deadline valuation functions. Further, the at least one data processing apparatus may release a portion of the scheduled computing resources that is associated with a set of the job objects that are associated with respective resource allocations that are insufficient for completion of execution of computing jobs associated with the set of job objects, after determining a first modification of the basic optimal fractional solution. Further, the at least one data processing apparatus may allocate the released portion to a group of the job objects that are associated with computing jobs that receive computing resources sufficient for completion of execution, in accordance with the determined basic optimal fractional solution.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The details of one or more implementations are set forth in the accompanying drawings and the description below. Other features will be apparent from the description and drawings, and from the claims.

### DRAWINGS

FIG. 1 is a block diagram of an example system for value-based scheduling.

FIG. 2 is a flowchart illustrating example operations of the system of FIG. 1.

FIG. 3 is a flowchart illustrating example operations of the system of FIG. 1.

FIG. 4 is a flowchart illustrating example operations of the system of FIG. 1.

### DETAILED DESCRIPTION

Many users are using services based on cloud computing services, as companies such as AMAZON, GOOGLE and MICROSOFT have begun to offer such services. The cloud may provide easily accessible and flexible allocation of computing resources and services, which may be rented on-demand to users, applications and businesses. This paradigm may provide a win-win situation among providers and users, as providers reduce costs through the economy of scale of large and efficient data centers, while users may invest less in private infrastructure and maintenance of hardware and software.

Two example pricing models in cloud systems may include (i) on-demand plans, wherein a user pays a fixed price for a virtual machine per unit time (e.g., per hour), and may either release or acquire servers on demand without making any prior reservations, and (ii) spot instances, where users may bid for resources, and may be allocated spot instances if the current spot price is below the user's bid. However, during the execution of a job, if a user's bid falls below market price, the job may be terminated abruptly, potentially losing the work already completed.

In the models discussed above, the user pays for computation as if it were a tangible commodity, rather than paying for desired performance. For example, a finance firm may desire services for processing daily stock exchange data with a deadline of an hour before the next trading day. Such a firm is not so concerned with the allocation of servers over time as long as the job is finished by its due date. However, the cloud service may be able to provide higher value to users by having knowledge of user-centric valuations for the limited resources for which their users are contending. This form of value-based scheduling is not supported by on-demand pricing, nor by spot pricing. Further, there may be no explicit incentives in conventional plans that prevent fluctuations between high and low utilization of computing resources. A goal of cloud operators may be to keep substantially all of their resources constantly utilized.

Example techniques discussed herein may provide a pricing model for batch computing in cloud environments, which focuses more on quality and quantity, rather than just quantity. For example, significance of the completion time of a batch job, rather than the exact number of servers that the job is allocated at any given time, may be incorporated into an example pricing model. According to example embodiments discussed herein, users (e.g., customers) may specify an overall amount of resources (e.g., servers or virtual machine hours) which they request for their job, as well as an amount the user may be willing to pay for these resources as a function of the completion time of the job. For example, a particular user may specify a request for a total of 1,000 server hours, and a willingness to pay $100 if these resources are delivered to the user no later than a deadline (e.g., due time) of 5 pm, and none if the resources are delivered after 5 pm.

This example request may be relevant for batch jobs (e.g., financial analytics, web crawling in a timely manner, search index updates) that are processed until completion. According to example embodiments discussed herein, the system (e.g., the cloud system) may determine an allocation of resources according to the jobs submitted, the users' willingness to pay, and the system's capacity constraints. As users may try to game the system by misreporting either their value or their deadline, and thus potentially increasing their utility, example techniques discussed herein may incentivize the users to report their true values (or willingness to pay) for different job completion dates (times).

As further discussed below, an example Decompose Relaxation and Draw (DRD) technique may obtain a constant factor of the social welfare, i.e., the sum of the values of jobs that are executed before their deadline. According to an example embodiment, incentive compatibility may be provided by the DRD technique based on decomposing an optimal fractional solution to a linear programming formulation of the problem into a set of feasible solutions. The decomposition may include a property that its average social welfare is an approximation to an optimal social welfare value.

As used herein, a “linear program” may refer to determining a way to achieve a “best result” (e.g., maximum profit or lowest cost), or optimization, based on a mathematical model for a set of requirements that may be indicated as linear relationships.

As further discussed below, an example Full-By-Relaxation (FBR) technique may provide an imitation of a basic (fractional) optimal linear programming (LP) solution by following its allocation for those computing jobs that are fully completed by their deadline, while not allocating any resources to other computing jobs. In this context, a “basic feasible solution” of an LP may include a vertex of a polyhedron defined by the LP constraints, which may not be written as a convex sum of other points of the polyhedron.

In this context, an “allocation” may refer to a mapping of computing resources to a computing job which fully executes the computing job.

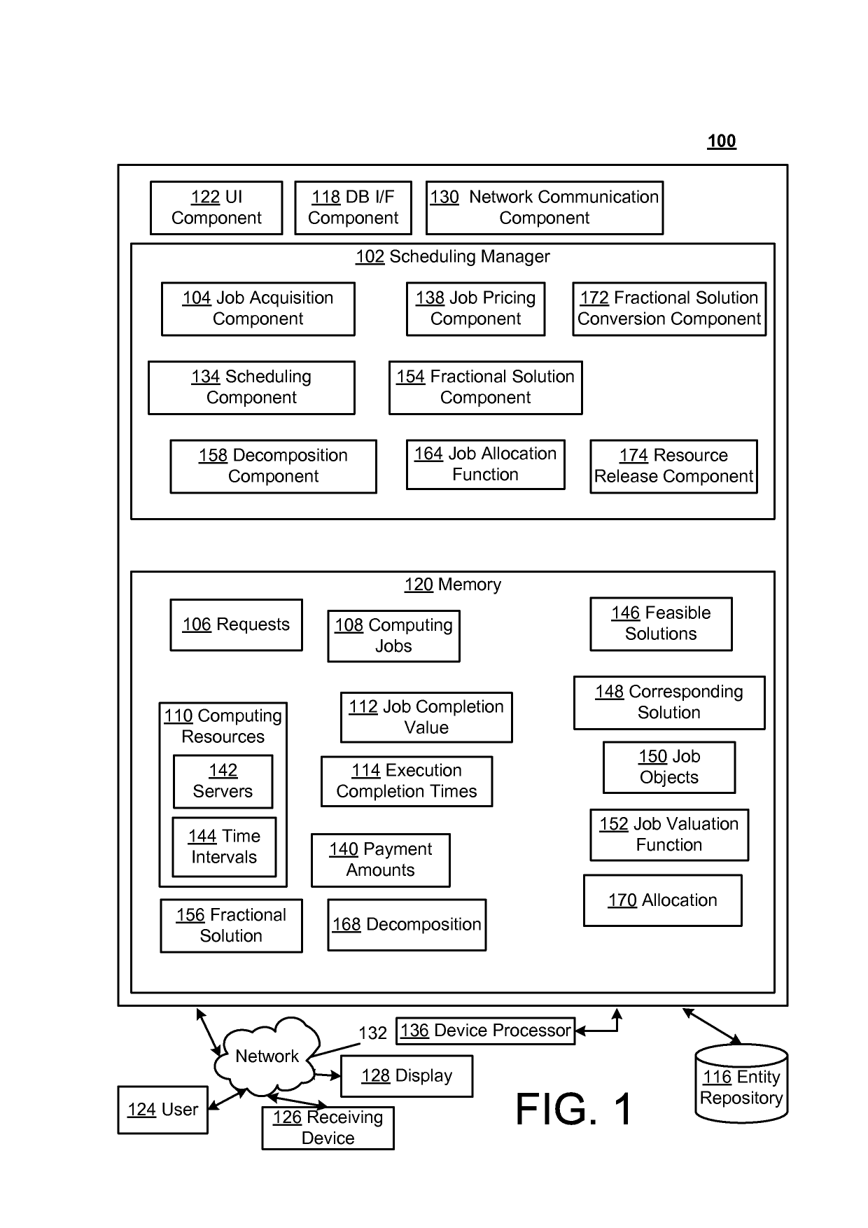

As further discussed herein, FIG. 1 is a block diagram of a system 100 for providing value-based scheduling. As shown in FIG. 1, a system 100 may include a scheduling manager 102 that includes a job acquisition component 104 that may obtain a plurality of requests 106 for execution of computing jobs 108 on one or more devices that include a plurality of computing resources 110, the one or more devices configured to flexibly allocate the plurality of computing resources 110, each of the computing jobs 108 including job completion values 112 representing a worth to a respective user that is associated with execution completion times 114 of each respective computing job 108.

In this context, a “computing job” may refer to a unit of work for one or more computing devices associated with completion of a complete task associated with a requestor (e.g., a user). In this context, “computing resources” may refer to various parts or features associated with the computing devices. For example, “computing resources” may include one or more of central processing unit (CPU) time, units of storage on storage devices, a number of computing devices (e.g., servers), or any other features associated with computing devices. For example, a “computing job” may include executable code, parameters indicating computing resources associated with execution of associated executable code, indicators associated with identification or location of executable code, or any other features describing entities needed for completion of the task (e.g., a weather forecast, a stock market analysis, a payroll update, a research analysis).

In this context, “flexible” allocation may refer to scheduling of a computing job such that the computing job may be allocated a different number of servers per time unit. For example, the allocation may be performed in a preemptive (e.g., non-contiguous) manner, under parallelism thresholds.

For example, a user may indicate a job completion value of one hundred dollars if his/her computing job is completed by midnight on a day of submission of the computing job, and a value of zero otherwise.

According to an example embodiment, the scheduling manager 102 may include executable instructions that may be stored on a computer-readable storage medium, as discussed below. According to an example embodiment, the computer-readable storage medium may include any number of storage devices, and any number of storage media types, including distributed devices. According to an example embodiment, the scheduling manager 102 may be implemented as a distributed system over a network that includes a plurality of distributed servers (e.g., a network cloud).

For example, an entity repository 116 may include one or more databases, and may be accessed via a database interface component 118. One skilled in the art of data processing will appreciate that there are many techniques for storing repository information discussed herein, such as various types of database configurations (e.g., SQL SERVERS) and non-database configurations.

According to an example embodiment, the scheduling manager 102 may include a memory 120 that may store the requests 106. In this context, a “memory” may include a single memory device or multiple memory devices configured to store data and/or instructions. Further, the memory 120 may span multiple distributed storage devices.

According to an example embodiment, a user interface component 122 may manage communications between a user 124 and the scheduling manager 102. The user 124 may be associated with a receiving device 126 that may be associated with a display 128 and other input/output devices. For example, the display 128 may be configured to communicate with the receiving device 126, via internal device bus communications, or via at least one network connection.

According to an example embodiment, the scheduling manager 102 may include a network communication component 130 that may manage network communication between the scheduling manager 102 and other entities that may communicate with the scheduling manager 102 via at least one network 132. For example, the at least one network 132 may include at least one of the Internet, at least one wireless network, or at least one wired network. For example, the at least one network 132 may include a cellular network, a radio network, or any type of network that may support transmission of data for the scheduling manager 102. For example, the network communication component 130 may manage network communications between the scheduling manager 102 and the receiving device 126. For example, the network communication component 130 may manage network communication between the user interface component 122 and the receiving device 126.

A scheduling component 134 may schedule the computing resources 110 based on the job completion values 112 associated with each respective computing job 108. For example, the scheduling component 134 may schedule the computing resources 110, via a device processor 136.

In this context, a “processor” may include a single processor or multiple processors configured to process instructions associated with a processing system. A processor may thus include multiple processors processing instructions in parallel and/or in a distributed manner. Although the device processor 136 is depicted as external to the scheduling manager 102 in FIG. 1, one skilled in the art of data processing will appreciate that the device processor 136 may be implemented as a single component, and/or as distributed units which may be located internally or externally to the scheduling manager 102, and/or any of its elements.

According to an example embodiment, the scheduling manager 102 may communicate directly (not shown in FIG. 1) with the receiving device 126, instead of via the network 132, as depicted in FIG. 1. For example, the scheduling manager 102 may reside on one or more backend servers, or on a desktop device, or on a mobile device. For example, although not shown in FIG. 1, the user 124 may interact directly with the receiving device 126, which may host at least a portion of the scheduling manager 102, at least a portion of the device processor 136, and the display 128. According to example embodiments, portions of the system 100 may operate as distributed modules on multiple devices, or may communicate with other portions via one or more networks or connections, or may be hosted on a single device.

According to an example embodiment, a job pricing component 138 may determine payment amounts 140 for charges to respective users associated with computing jobs 108 for which the computing resources 110 are allocated, based on the scheduling, based on incentivizing the respective users to submit true values associated with the respective job completion values 112.

In this context, “true value” may refer to the actual value to a user if his/her computing job is completed by a particular due time. For example, a true value to a user of a stock market analysis computing job may be several thousand dollars if execution of the computing job is completed by 10 a.m. on a Tuesday morning, and zero if completed after that time.

According to an example embodiment, the computing resources 110 may include time slots that represent one or more networked servers 142 and time intervals 144 associated with use of the one or more networked servers 142. For example, the time slots may represent units of CPU usage per hour, or units of a number of servers per hour. One skilled in the art of data processing will understand that many different types of features associated with computing devices may be indicated as “computing resources,” and may further be represented in association with references to “time slots,” without departing from the spirit of the discussion herein.

According to an example embodiment, the scheduling component 134 may schedule the computing resources 110 based on determining a set of feasible solutions 146 for execution processing of the computing jobs 108 in accordance with:

maximize Σⱼ₌₁ⁿvⱼxⱼ

such that Σ_{t≦d}_{ⱼ}yⱼ(t)=Dⱼ·xⱼ ∀ j ∈

[symbol]

Σ_{j:t≦d}_{ⱼ}yⱼ(t)≦C ∀ t ∈

[symbol]

0≦yⱼ(t)≦kⱼ ∀ j ∈ [symbol] , t≦dⱼ, and

xⱼ ∈ {0,1 } ∀ j ∈ [symbol]
wherein
n represents a count of the computing jobs with associated users,
dⱼ represents a deadline value indicating a deadline for completion of execution of computing job j,
vⱼ represents the job completion value associated with the respective computing job j, indicating a value gained by a respective user j if computing job j is completed by the deadline,
xⱼ, represents a value indicating whether computing job j is fully allocated or unallocated,
yⱼ represents an allocation of computing resources to computing job j per time interval t,
C represents a predetermined capacity count of servers,
Dⱼ represents a demand value of computing job j indicating a number of server/time interval units associated with completion of execution of computing job j,
kⱼ represents a maximal number of computing resources allowed for allocation to computing job j in a time interval unit,
J represents the n computing jobs, and
T represents a plurality of time intervals associated with respective time intervals assigned for execution of the computing jobs.

One skilled in the art of data processing will understand, however, that many other techniques may be used for scheduling the computing resources 110 based on the job completion values 112 associated with each respective computing job 108, without departing from the spirit of the discussion herein.

According to an example embodiment, the scheduling component 134 may schedule the computing resources 110 based on determining a set of feasible solutions 146 for execution processing of the computing jobs 108 in accordance with:

maximize Σⱼ₌₁ⁿΣₑ₌₁^{T}vⱼ(e)xⱼ_{^{e}}

such that Σ_{t≦e}yⱼ_{^{e}}(t)=Dⱼ·xⱼ ∀ j^{e} ∈

[symbol]

Σ_{j,e}yⱼ_{^{e}}(t)≦C ∀ t ∈

[symbol]

Σₑ₌₁^{T}xⱼ_{^{e}}≦1 ∀j ∈

[symbol]

xⱼ_{^{e}} ∈ {0,1} ∀ j^{e} ∈ [symbol] , and

0≦jⱼ_{^{e}}(t)≦kⱼ ∀ j^{e} ∈ [symbol] t ∈ [symbol] ,
wherein
each respective user is represented as respective subusers j¹, j² . . . , j^{T}, wherein T represents a last time interval unit associated with execution of the computing job associated with the respective user,
each respective subuser j^{e} is associated with a deadline valuation function that includes a value of vⱼ (e) and deadline e,
n represents a count of the computing jobs with associated users,
vⱼ represents a set of job completion values associated with the respective computing job j, wherein vⱼ (t) indicates a value gained by a respective user j if computing job j is completed at time t,
xⱼ_{^{e}} represents a value indicating whether computing job j is fully allocated or unallocated with respect to a corresponding subuser j^{e},
yⱼ_{^{e}} represents an allocation of computing resources to computing job j per time interval t with respect to a corresponding subuser j^{e},
C represents a predetermined capacity count of servers,
Dⱼ represents a demand value of computing job j indicating a number of server/time interval units associated with completion of execution of computing job j,
kⱼ represents a maximal number of computing resources allowed for allocation to computing job j in a time interval unit,
J represents the n computing jobs, and
T represents a plurality of time intervals associated with respective time intervals assigned for execution of the computing jobs.

According to an example embodiment, the job acquisition component 104 may obtain a plurality of job objects 150, each of the job objects 150 including a job valuation function 152 representing a worth to a respective user that is associated with execution completion times 114 of respective computing jobs 108 that are associated with each respective job object 150.

In this context, a “job object” may refer to an entity associated with a computing job. For example, a job object may represent a unit of work for one or more computing devices associated with completion of a complete task associated with a requestor (e.g., a user), and may include parameters and/or descriptors associated with completion of the task.

A fractional solution component 154 may determine an optimal fractional solution 156 associated with a relaxed linear program (LP) for scheduling computing resources 110 for execution of the computing jobs 108 associated with each respective job object 150, based on a bounded scheduling problem based on maximizing an objective that is based on the respective job valuation functions 152.

A decomposition component 158 may determine a decomposition 168 of the optimal fractional solution 156 that includes a plurality of solutions, each solution determining an allocation 170 of the computing resources 110.

According to an example embodiment, the scheduling component 134 may schedule the computing resources 110 based on the decomposition 168.

According to an example embodiment, the fractional solution component 154 may determine the optimal fractional solution 156 in accordance with:

maximize Σⱼ₌₁ⁿΣₑ₌₁^{T}vⱼ(e)xⱼ_{^{e}}

such that Σ_{t≦e}yⱼ_{^{e}}(t)=Dⱼ·xⱼ ∀ j^{e} ∈ [symbol] ,

Σ_{j,e}yⱼ_{^{e}}(t)≦C ∀ t ∈ [symbol] ,

Σₑ₌₁^{T}xⱼ_{^{e}}≦1 ∀j ∈ [symbol] ,

0≦xⱼ_{^{e}} ∀ j^{e} ∈ [symbol] ,

0≦yⱼ_{^{e}}(t)≦kⱼ ∀ j^{e} ∈ [symbol] , t ∈ [symbol] and

yⱼ_{^{e}}(t)≦kⱼxⱼ_{^{e}} ∀j^{e} ∈ [symbol] , t≦dⱼ,
wherein
each respective user is represented as respective subusers j¹, j² . . . , j^{T}, wherein

T represents a last time interval unit associated with execution of the computing job associated with the respective user,
each respective subuser j^{e} is associated with a deadline valuation function that includes a value of vⱼ (e) and deadline e,
n represents a count of the computing jobs with associated users,
vⱼ represents a set of job completion values associated with the respective computing job j, wherein vⱼ (t) indicates a value gained by a respective user j if computing job j is completed at time t,
xⱼ_{^{e}} represents a value indicating whether computing job j is fully allocated or unallocated with respect to a corresponding subuser j^{e},
yⱼ_{^{e}} represents an allocation of computing resources to computing job j per time interval t with respect to a corresponding subuser j^{e},
C represents a predetermined capacity count of servers,
kⱼ represents a parallelism value indicating a measure of parallelism potential associated with execution of the corresponding computing job j,
Dⱼ represents a demand value of computing job j indicating a number of server/time interval units associated with completion of execution of computing job j,
J represents the n computing jobs, and
T represents a plurality of time intervals associated with respective time intervals assigned for execution of the computing jobs.

One skilled in the art of data processing will understand, however, that many other techniques may be used for determining optimal fractional solutions, without departing from the spirit of the discussion herein.

According to an example embodiment, a fractional solution conversion component 172 may initiate a conversion of the optimal fractional solution 156 into a corresponding value-equivalent solution 148, wherein allocations 170 of the computing resources 110, per time interval 144, to the computing jobs 108 that are associated with the optimal fractional solution 156 correspond to monotonically non-decreasing functions.

According to an example embodiment, the decomposition component 158 may determine the decomposition 168 of the optimal fractional solution 156 based on determining a decomposition 168 of the corresponding value-equivalent solution 148 that includes a plurality of solutions, each solution determining an allocation 170 of the computing resources 110.

According to an example embodiment, a resource release component 174 may initiate a release of a portion of the scheduled computing resources 110 that is associated with a set of the job objects 150 that are associated with respective resource allocations 170 that are insufficient for completion of execution of computing jobs 108 associated with the set of job objects 150, after determining a first modification of the optimal fractional solution 156.

For example, the first modification may include a conversion to a monotonically non-decreasing (MND) form in which every job may be completed exactly at a corresponding declared deadline.

According to an example embodiment, the scheduling component 134 may allocate the released portion to a group of the job objects 150 that are associated with computing jobs 108 that receive computing resources 110 sufficient for completion of execution, in accordance with the determined basic optimal fractional solution 156.

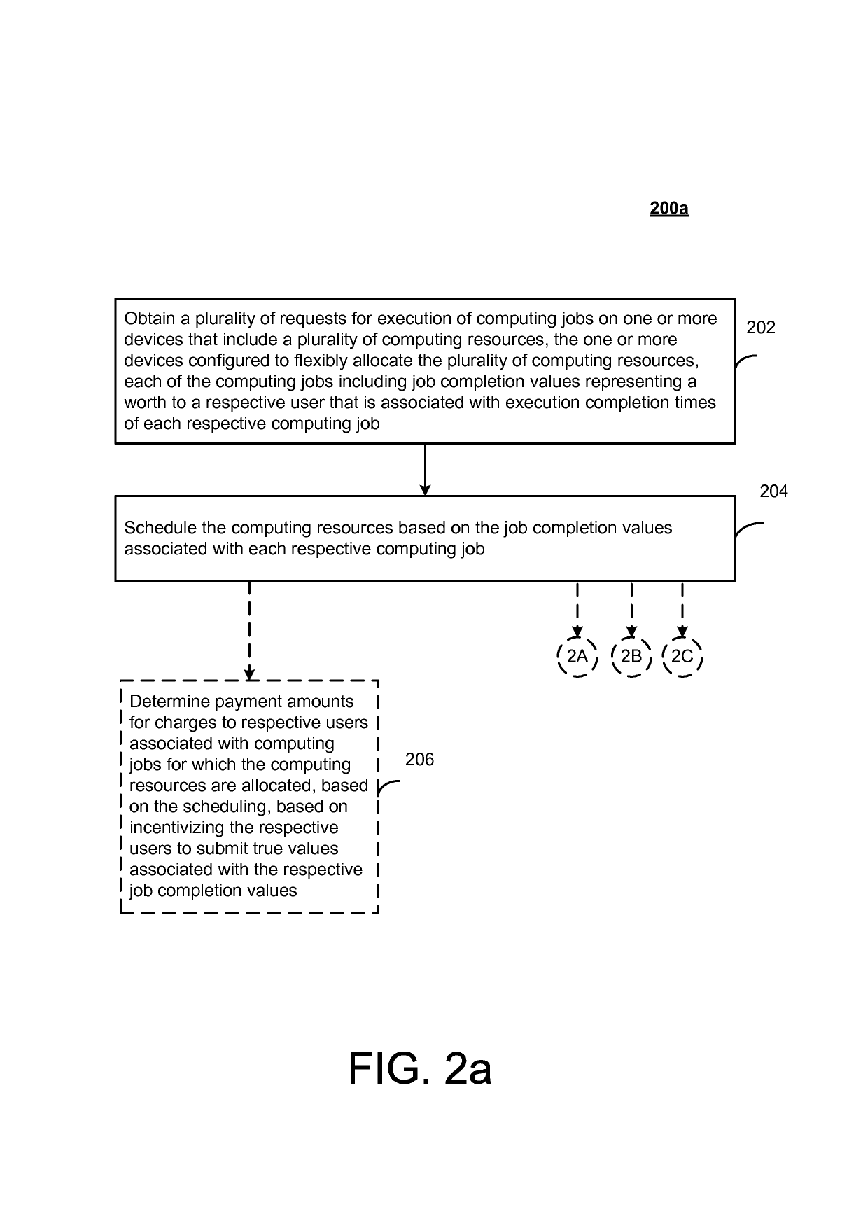

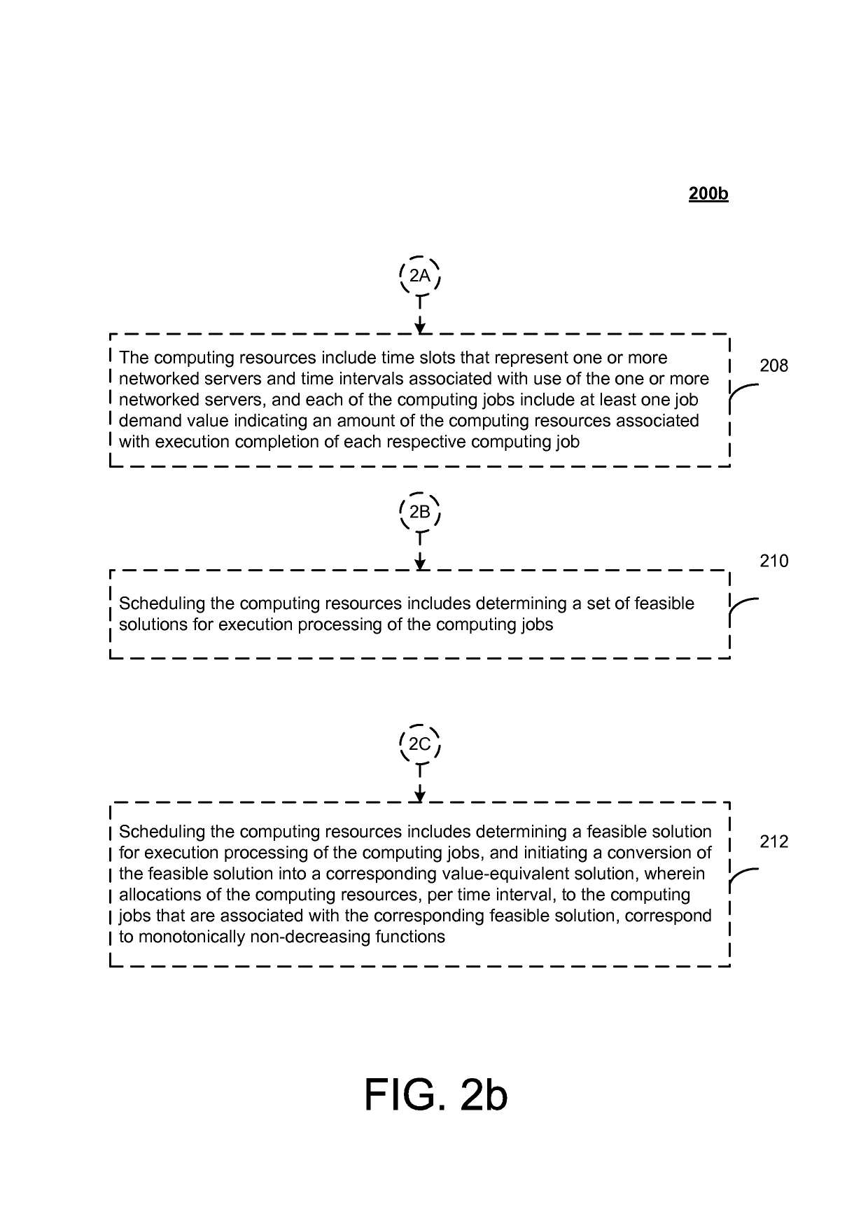

FIG. 2 is a flowchart illustrating example operations of the system of FIG. 1, according to example embodiments. In the example of FIG. 2a, a plurality of requests for execution of computing jobs on one or more devices that include a plurality of computing resources may be obtained, the one or more devices configured to flexibly allocate the plurality of computing resources, each of the computing jobs including job completion values representing a worth to a respective user that is associated with execution completion times of each respective computing job (202). For example, the job acquisition component 104 may obtain a plurality of requests 106 for execution of computing jobs 108 on one or more devices that include a plurality of computing resources 110, the one or more devices configured to flexibly allocate the plurality of computing resources 110, each of the computing jobs 108 including job completion values 112 representing a worth to a respective user that is associated with execution completion times 114 of each respective computing job 108, as discussed above.

The computing resources may be scheduled based on the job completion values associated with each respective computing job (204). For example, the scheduling component 134 may schedule the computing resources 110 based on the job completion values 112 associated with each respective computing job 108, as discussed above.

According to an example embodiment, payment amounts for charges to respective users associated with computing jobs for which the computing resources are allocated may be determined, based on the scheduling, based on incentivizing the respective users to submit true values associated with the respective job completion values (206). For example, the job pricing component 138 may determine payment amounts 140 for charges to respective users associated with computing jobs 108 for which the computing resources 110 are allocated, based on the scheduling, based on incentivizing the respective users to submit true values associated with the respective job completion values 112, as discussed above.

According to an example embodiment, the computing resources may include time slots that represent one or more networked servers and time intervals associated with use of the one or more networked servers, and each of the computing jobs include at least one job demand value indicating an amount of the computing resources associated with execution completion of each respective computing job (208). For example, the computing resources 110 may include time slots that represent one or more networked servers 142 and time intervals 144 associated with use of the one or more networked servers 142, as discussed above.

According to an example embodiment, scheduling the computing resources may include determining a set of feasible solutions for execution processing of the computing jobs (210). For example, the scheduling component 134 may schedule the computing resources 110 based on determining a set of feasible solutions 146 for execution processing of the computing jobs 108, as discussed above.

According to an example embodiment, scheduling the computing resources may include determining a feasible solution for execution processing of the computing jobs, and initiating a conversion of the feasible solution into a corresponding value-equivalent solution, wherein allocations of the computing resources, per time interval, to the computing jobs that are associated with the corresponding feasible solution, correspond to monotonically non-decreasing functions (212), as discussed further herein.

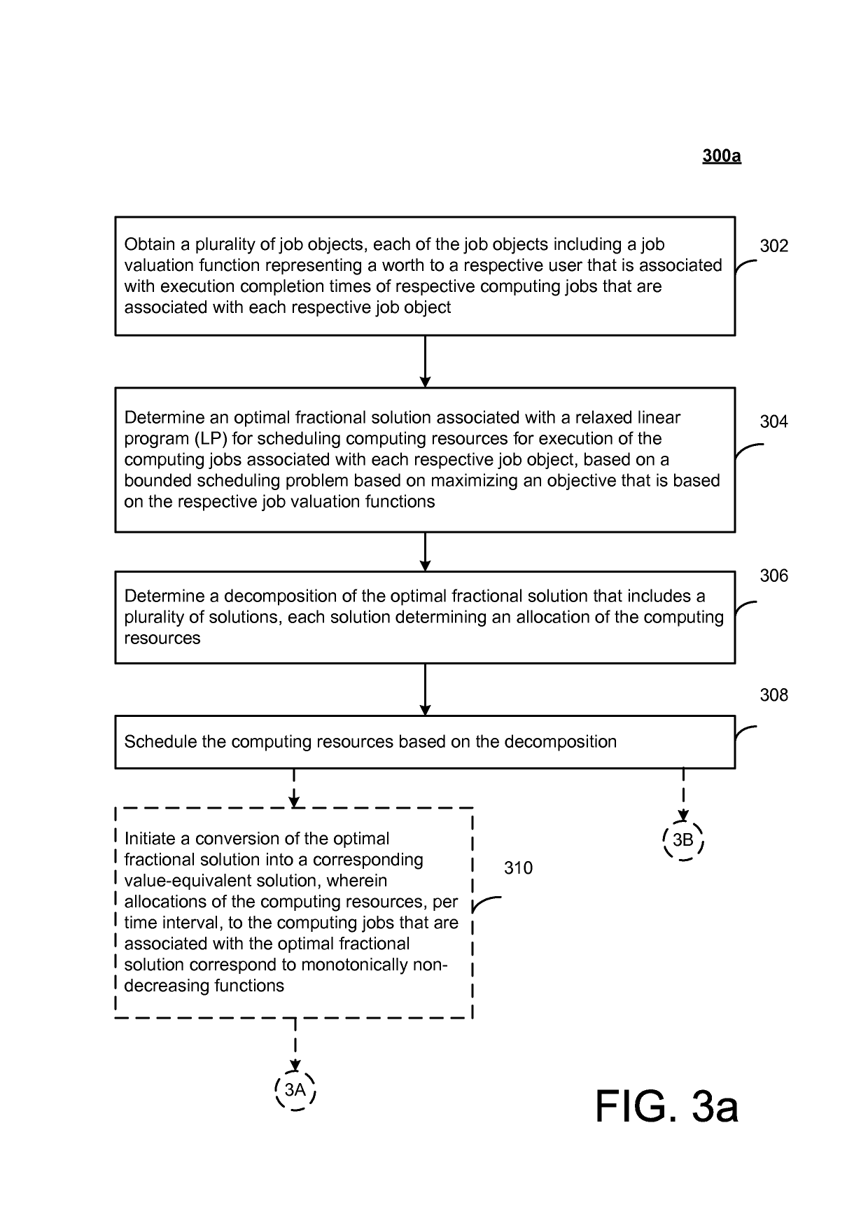

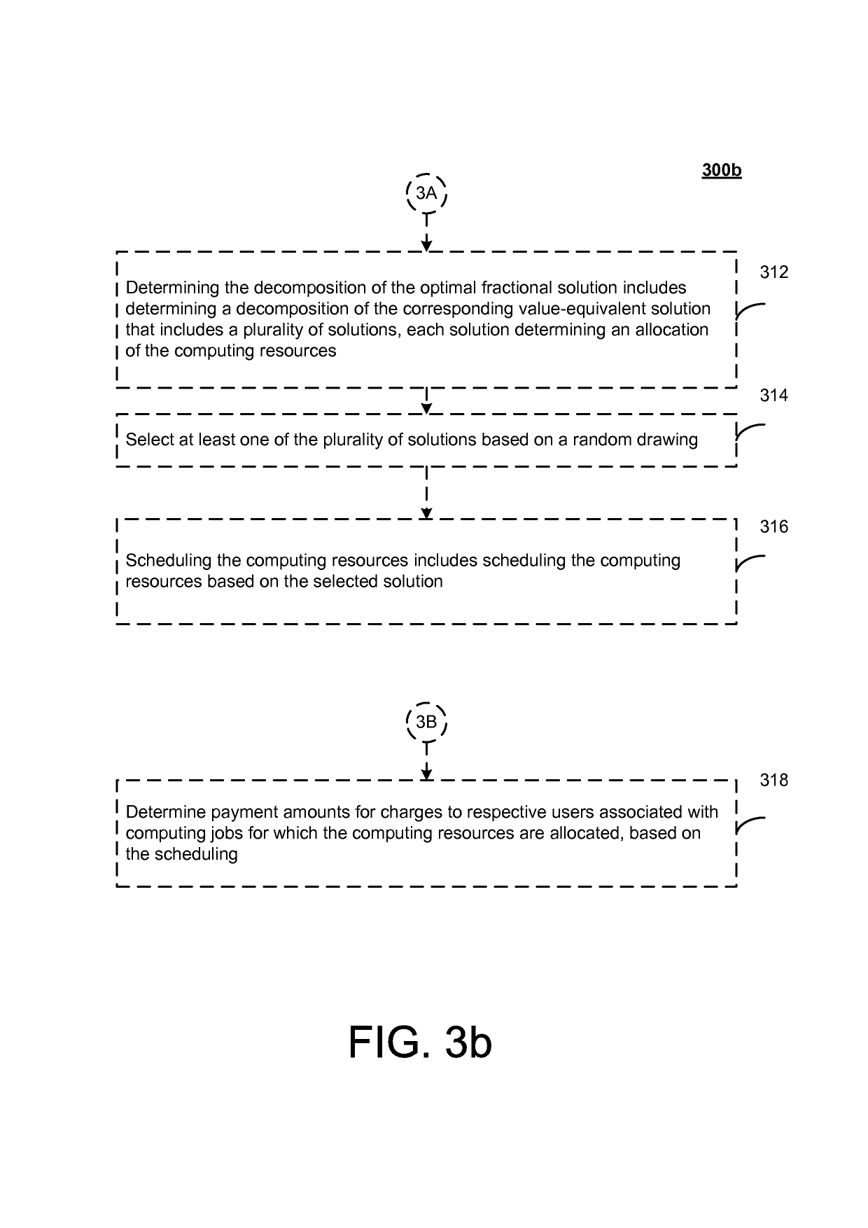

FIG. 3 is a flowchart illustrating example operations of the system of FIG. 1, according to example embodiments. In the example of FIG. 3, a plurality of job objects may be obtained, each of the job objects including a job valuation function representing a worth to a respective user that is associated with execution completion times of respective computing jobs that are associated with each respective job object (302). For example, the job acquisition component 104 may obtain a plurality of job objects 150, each of the job objects 150 including a job valuation function 152 representing a worth to a respective user that is associated with execution completion times 114 of respective computing jobs 108 that are associated with each respective job object 150, as discussed above.

An optimal fractional solution associated with a relaxed linear program (LP) for scheduling computing resources for execution of the computing jobs associated with each respective job object may be determined, based on a bounded scheduling problem based on maximizing an objective that is based on the respective job valuation functions (304). For example, the fractional solution component 154 may determine an optimal fractional solution 156 associated with a relaxed linear program (LP) for scheduling computing resources 110 for execution of the computing jobs 108 associated with each respective job object 150, based on a bounded scheduling problem based on maximizing an objective that is based on the respective job valuation functions 152, as discussed above.

A decomposition of the optimal fractional solution that includes a plurality of solutions may be determined, each solution determining an allocation of the computing resources (306). For example, the decomposition component 158 may determine a decomposition 168 of the optimal fractional solution 156 that includes a plurality of solutions, each solution determining an allocation 170 of the computing resources 110, as discussed above.

The computing resources may be scheduled based on the decomposition (308).

According to an example embodiment, the optimal fractional solution 156 may be determined in accordance with:

maximize Σⱼ₌₁ⁿΣₑ₌₁^{T}vⱼ(e)xⱼ_{^{e}}

such that Σ_{t≦e}yⱼ_{^{e}}(t)=Dⱼ·xⱼ ∀ j^{e} ∈ [symbol] ,

Σ_{j,e}yⱼ_{^{e}}(t)≦C ∀ t ∈ [symbol] ,

Σₑ₌₁^{T}xⱼ_{^{e}}≦1 ∀j ∈ [symbol] ,

0≦xⱼ_{^{e}} ∀ j^{e} ∈ [symbol] ,

0≦jⱼ_{^{e}}(t)≦kⱼ ∀ j^{e} ∈ [symbol] , t ∈ [symbol] and

yⱼ_{^{e}}(t)≦kⱼxⱼ_{^{e}} ∀j^{e} ∈ [symbol] , t≦dⱼ,
wherein
each respective user is represented as respective subusers j¹, j² . . . , j^{T}, wherein T represents a last time interval unit time associated with execution of the computing job associated with the respective user,
each respective subuser j^{e} is associated with a deadline valuation function that includes a value of vⱼ(e) and deadline e,
n represents a count of the computing jobs with associated users,
vⱼ represents a set of job completion values associated with the respective computing job j, wherein vⱼ(t) indicates a value gained by a respective user j if computing job j is completed at time t,
xⱼ_{^{e}} represents a value indicating whether computing job j is fully allocated or unallocated with respect to a corresponding subuser j^{e},
yⱼ_{^{e}} represents an allocation of computing resources to computing job j per time interval t with respect to a corresponding subuser j^{e},
C represents a predetermined capacity count of servers,
kⱼ represents a parallelism value indicating a measure of parallelism potential associated with execution of the corresponding computing job j,
Dⱼ represents a demand value of computing job j indicating a number of server/time interval units associated with completion of execution of computing job j,
J represents the n computing jobs, and
T represents a plurality of time intervals associated with respective time intervals assigned for execution of the computing jobs.

In this context, a “deadline valuation function” may refer to a step function that may have a value of vⱼ up to a deadline dⱼ and 0 afterwards.

One skilled in the art of data processing will understand, however, that many other techniques may be used for determining the optimal fractional solution 156, without departing from the spirit of the discussion herein.

According to an example embodiment, a conversion of the optimal fractional solution into a corresponding value-equivalent solution may be initiated, wherein allocations of the computing resources, per time interval, to the computing jobs that are associated with the optimal fractional solution correspond to monotonically non-decreasing functions (310). For example, the fractional solution conversion component 172 may initiate a conversion of the optimal fractional solution 156 into a corresponding value-equivalent solution 148, wherein allocations 170 of the computing resources 110, per time interval 144, to the computing jobs 108 that are associated with the optimal fractional solution 156 correspond to monotonically non-decreasing functions, as discussed further herein.

According to an example embodiment, determining the decomposition of the optimal fractional solution may include determining a decomposition of the corresponding value-equivalent solution that includes a plurality of solutions, each solution determining an allocation of the computing resources (312). For example, the decomposition component 158 may determine the decomposition 168 of the optimal fractional solution 156 based on determining a decomposition 168 of the corresponding value-equivalent solution 148 that includes a plurality of solutions, each solution determining an allocation 170 of the computing resources 110, as discussed further herein.

According to an example embodiment, at least one of the plurality of solutions may be selected based on a random drawing (314), as discussed further herein.

According to an example embodiment, scheduling the computing resources may include scheduling the computing resources based on the selected solution (316), as discussed further herein.

According to an example embodiment, payment amounts for charges to respective users associated with computing jobs for which the computing resources are allocated may be determined, based on the scheduling (318), as discussed further herein.

According to an example embodiment, the payment amounts 140 may be determined (e.g., via the job pricing component 138) in accordance with:

pⱼ(b)=OPT·(b₋ⱼ)−(OPT*(b)−vⱼ(OPT*(b))),
wherein
pⱼ(b) represents a payment amount associated with a user j,
b represents a bid vector (b₁, . . . , bₙ) corresponding to bid valuation functions bⱼ obtained from respective users j,
OPT*(b) represents an optimal fractional social welfare value associated with b,
vⱼ(OPT*(b)) represents a value gained by user j in OPT*(b), and
OPT*(b₋ⱼ) represents an optimal fractional solution without user j participating.

According to an example embodiment, the payment amounts 140 may be determined (e.g., via the job pricing component 138) in accordance with:

$$\frac{{p}_{j} ( b )}{α \cdot {x}_{j}^{*}} ,$$

wherein xⱼ* represents a completed fraction of a computing job j associated with user j in determination of OPT*(b), and

α represents an approximation factor constant.

One skilled in the art of data processing will understand, however, that many other techniques may be used for determining the payment amounts, without departing from the spirit of the discussion herein.

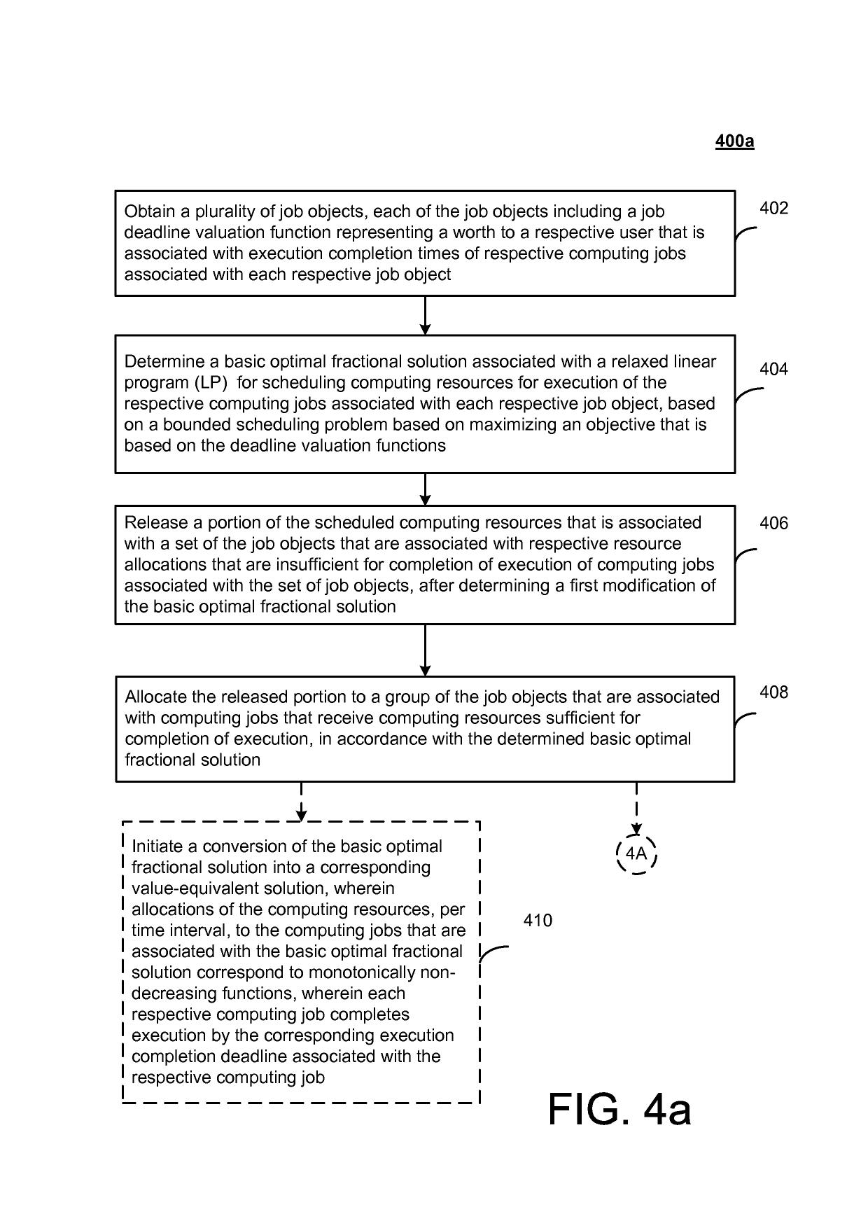

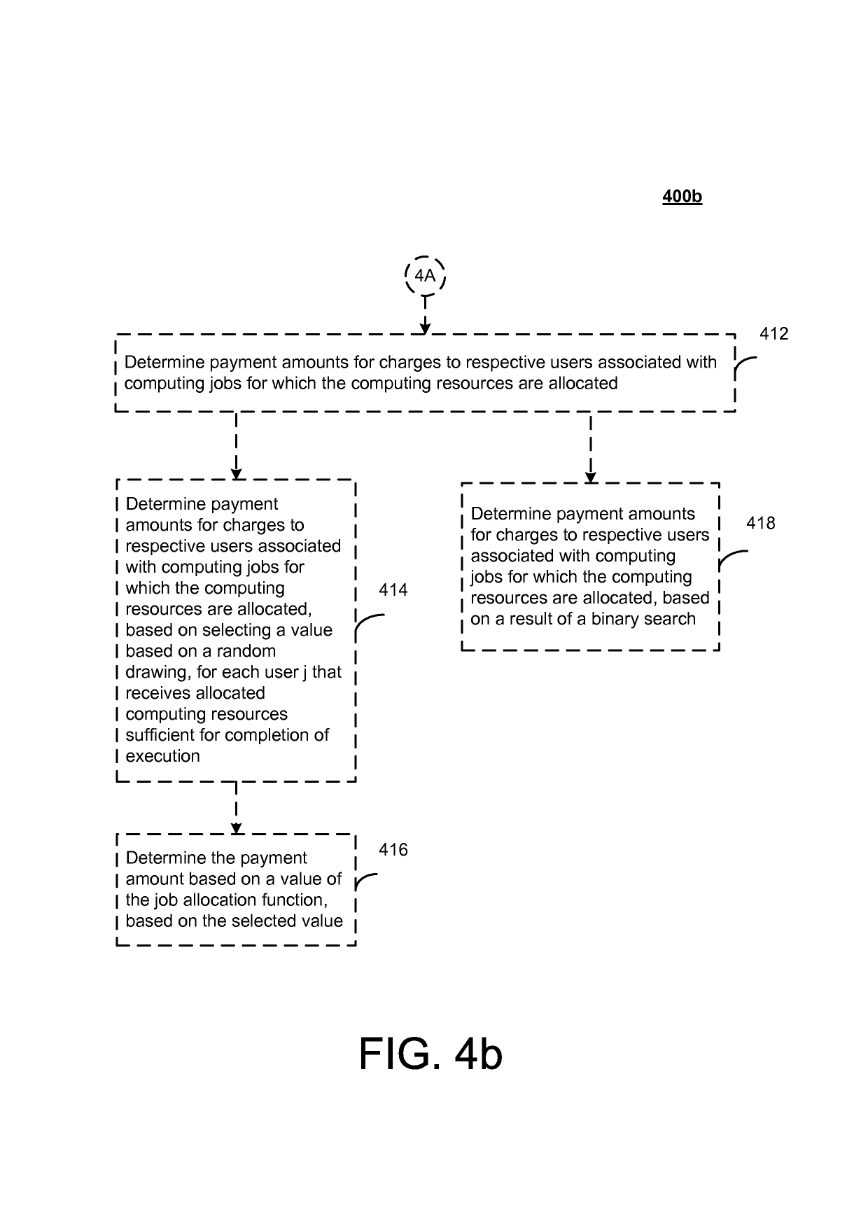

FIG. 4 is a flowchart illustrating example operations of the system of FIG. 1, according to example embodiments. In the example of FIG. 4a, a plurality of job objects may be obtained, each of the job objects including a job deadline valuation function representing a worth to a respective user that is associated with execution completion times of respective computing jobs associated with each respective job object (402). For example, the job acquisition component 104 may obtain a plurality of job objects 150, as discussed above.

An optimal fractional solution associated with a relaxed linear program (LP) for scheduling computing resources for execution of the computing jobs associated with each respective job object may be determined, based on a bounded scheduling problem based on maximizing an objective that is based on the respective job valuation functions (404). For example, the fractional solution component 154 may determine an optimal fractional solution 156 associated with a relaxed linear program (LP) for scheduling computing resources 110 for execution of the computing jobs 108 associated with each respective job object 150, based on a bounded scheduling problem based on maximizing an objective that is based on the respective job valuation functions 152, as discussed above.

A portion of the scheduled computing resources that is associated with a set of the job objects that are associated with respective resource allocations that are insufficient for completion of execution of computing jobs associated with the set of job objects may be released, after determining a first modification of the basic optimal fractional solution (406). For example, the resource release component 174 may initiate a release of a portion of the scheduled computing resources 110 that is associated with a set of the job objects 150 that are associated with respective resource allocations 170 that are insufficient for completion of execution of computing jobs 108 associated with the set of job objects 150, after determining a first modification of the optimal fractional solution 156, as discussed further herein.

The released portion may be allocated to a group of the job objects that are associated with computing jobs that receive computing resources sufficient for completion of execution, in accordance with the determined basic optimal fractional solution (408). For example, the scheduling component 134 may allocate the released portion to a group of the job objects 150 that are associated with computing jobs 108 that receive computing resources 110 sufficient for completion of execution, in accordance with the determined basic optimal fractional solution 156, as discussed further herein.

According to an example embodiment, the basic optimal fractional solution 156 may be determined (e.g., via the fractional solution component 154) in accordance with:

maximize Σⱼ₌₁ⁿvⱼxⱼ

such that Σ_{t≦d}_{ⱼ}yⱼ(t)=Dⱼ·xⱼ ∀ j ∈ [symbol] ,

Σ_{j:t≦d}_{ⱼ}yⱼ(t)≦C ∀ t ∈ [symbol] ,

0≦yⱼ(t) ∀ j ∈ [symbol] , t≦dⱼ,

0≦xⱼ≦1 ∀ j ∈ [symbol] , and

yⱼ(t)≦kₖxⱼ ∀ j ∈ [symbol] , t≦dⱼ,
wherein
n represents a count of the computing jobs with associated users,
dⱼ represents a deadline value indicating a deadline for completion of execution of computing job j,
vⱼ represents a job completion value associated with the respective computing job j, indicating a value gained by a respective user j if computing job j is completed by the deadline,
xⱼ represents a value indicating whether computing job j is fully allocated or unallocated,
yⱼ represents an allocation of computing resources to computing job j per time interval t,
C represents a predetermined capacity count of servers,
Dⱼ represents a demand value of computing job j indicating a number of server/time interval units associated with completion of execution of computing job j,
kⱼ represents a parallelism value indicating a measure of parallelism potential associated with execution of the corresponding computing job j,
J represents the n computing jobs, and
T represents a plurality of time intervals associated with respective time intervals assigned for execution of the computing jobs.

One skilled in the art of data processing will understand, however, that many other techniques may be used for determining the basic optimal fractional solution 156, without departing from the spirit of the discussion herein.

According to an example embodiment, a conversion of the basic optimal fractional solution into a corresponding value-equivalent solution may be initiated, wherein allocations of the computing resources, per time interval, to the computing jobs that are associated with the basic optimal fractional solution correspond to monotonically non-decreasing functions, wherein each respective computing job completes execution by the corresponding execution completion deadline associated with the respective computing job (410). For example the fractional solution conversion component 172 may initiate a conversion of the optimal fractional solution 156 into a corresponding value-equivalent solution 148, as discussed above.

According to an example embodiment, payment amounts for charges to respective users associated with computing jobs for which the computing resources are allocated may be determined (412).

For example, the job pricing component 138 may determine payment amounts for charges to respective users associated with computing jobs 108 for which the computing resources 110 are allocated, in accordance with:

pⱼ(b)=v′ⱼƒⱼ(v′ⱼ, d′ⱼ)−∫₀^{v′is j}ƒⱼ(s,d′ⱼ)ds,
wherein
b represents a bid associated with a user j,
ƒⱼ represents a binary and value-monotonic job allocation function associated with the user j,
d′ⱼ represents a corresponding due time declared by the user j for the completion of the execution processing, and
v′ⱼ represents a job completion value declared by a respective user j, indicating a value gained by the user j if computing job j is completed by a deadline.

One skilled in the art of data processing will understand, however, that many other techniques may be used for determining the payment amounts, without departing from the spirit of the discussion herein.

According to an example embodiment, payment amounts for charges to respective users associated with computing jobs for which the computing resources are allocated may be determined, based on selecting a value based on a random drawing, for each user j that receives allocated computing resources sufficient for completion of execution (414).

According to an example embodiment, the payment amount may be determined based on a value of the job allocation function, based on the selected value (416).

According to an example embodiment, payment amounts 140 for charges to respective users associated with computing jobs 108 for which the computing resources 110 are allocated may be determined, based on:

selecting a value

s ∈ [0,v′ⱼ],

based on a random drawing, for each user j that receives allocated computing resources sufficient for completion of execution, and determining the payment amount based on a value of the value-monotonic job allocation function.

For example, a randomized sampling technique may be used to fix the bids of all users but j. A new bid value s ∈ [0, v′ⱼ] may be drawn andƒⱼ(s, dⱼ) may be calculated. If j is not allocated, the user may be charged v′ⱼ, otherwise, 0. The expected payment that is charged from user j is pⱼ(b). This procedure may be repeated multiple times and the user may be charged the average payment.

According to an example embodiment, payment amounts for charges to respective users associated with computing jobs for which the computing resources are allocated may be determined, based on a result of a binary search over a range of [0, v′ⱼ], the binary search based on the value-monotonic job allocation function (418).

For example, the binary search may be performed to search for the minimal point where ƒⱼ returns 1 in [0, v′ⱼ], where v′ⱼ is the bid value reported by user j. Since the searched domain is continuous, the search may be stopped when a threshold assurance value is reached.

One skilled in the art of data processing will understand, however, that many other techniques may be used for determining the payment amounts, without departing from the spirit of the discussion herein.

According to an example embodiment, users may submit computing jobs with a value function that specifies willingness to pay as a function of computing job due dates (times). Focusing on social-welfare as the system objective (e.g., relevant for private or in-house clouds), a resource allocation algorithm may obtain a (small) constant-factor approximation of maximum aggregate value, assuming that user valuations are known. Based on this algorithm, a truthful-in-expectation mechanism may be applied to the problem, thereby facilitating its implementation in actual systems.

Cloud computing may provide easily accessible computing resources of variable size and capabilities. This paradigm allows users of applications to rent computing resources and services on-demand, benefiting from the allocation flexibility and the economy of scale of large data centers. Cloud computing providers, such as AMAZON, GOOGLE and MICROSOFT, offer cloud hosting of user applications under a utility pricing model. The most common purchasing options are pay-as-you-go (or on-demand) schemes, in which users pay per-unit resource (e.g., a virtual machine) per-unit time (e.g., per hour).

Pricing in shared computing systems such as cloud computing may have diverse objectives, such as maximizing profits, or optimizing system-related metrics (e.g., delay or throughput). Example embodiments discussed herein may focus on maximizing the social welfare, i.e., the sum of users' values. For example, this objective may be relevant for private or in-house clouds, such as a government cloud, or enterprise computing clusters.

According to example embodiments discussed herein, a truthful-in-expectation mechanism for a scheduling problem, referred to herein as the Bounded Flexible Scheduling (BFS) problem, may be motivated by a cloud computing paradigm. A cloud that includes C servers may receive a set of job requests with heterogeneous demand and values per deadline (or due date), where the objective is maximizing the social welfare, i.e., the sum of the values of the scheduled computing jobs. The scheduling of a computing job may be flexible, i.e., it may be allocated a different number of servers per time unit and in a possibly preemptive (non-contiguous) manner, under parallelism thresholds. The parallelism threshold may represent the computing job's limitations on parallelized execution. For every computing job j, kⱼ may denote the maximum number of servers that may be allocated to computing job j in any given time unit. The maximal parallelism thresholds across computing jobs, denoted by k, may be much smaller than the cloud capacity C.

As discussed further below, the parallelism threshold constraint may be relaxed.

E. L. Lawler, “A dynamic programming algorithm for preemptive scheduling of a single machine to minimize the number of late jobs,” Annals of Operation Research, 26 (1991), pp. 125-133, provides an optimal solution in pseudo-polynomial time via dynamic programming to the problem of maximizing the profit of preemptively scheduling computing jobs on a single server, implying also a fully polynomial-time approximation scheme (FPTAS) for the solution. However, the algorithm discussed therein does not address an environment where computing jobs have parallelization limits.

According to an example embodiment, an LP-based approximation algorithm for BFS may provide an approximation factor of

$$α {=}^{Δ} ( 1 + \frac{C}{C - k} ) ( 1 + ɛ )$$

to the optimal social welfare for every ε>0. With a large gap between k and C, the approximation factor may approach a value of 2. The running time of the example algorithm, apart from solving the linear program, is polynomial in the number of computing jobs, the number of time slots and

$$\frac{1}{ɛ} .$$

As discussed below, an LP formulation for the BFS problem may have a substantial integrality gap. Thus, this LP may be strengthened by incorporating additional constraints that decrease the integrality gap. As discussed herein, an example reallocation algorithm may convert solutions of the LP to a value-equivalent canonical form, in which the number of servers allocated per computing job does not decrease over the execution period of the computing job. As discussed herein, an example approximation algorithm may decompose the optimal solution in canonical form to a relatively small number of feasible BFS solutions, with their average social welfare being an α-approximation (thus, at least one of them is an α-approximation). As discussed further herein, computing jobs may be allocated non-preemptively, i.e., computing jobs may be executed in one shot without interruption. This property may have significance, as it may avoid using significant network and storage resources for checkpointing intermediate state of computing jobs that are distributed across multiple servers running in parallel.

According to example embodiments, the approximation algorithm may be modified to provide a decomposition of an optimal fractional solution. This decomposition may be used to simulate (in expectation) a “fractional” VCG mechanism, which may be truthful.

A truthful-in-expectation mechanism for packing problems that are solved through LP-based approximation algorithms is discussed by R. Lavi and C. Swamy, “Truthful and near-optimal mechanism design via linear programming,” In FOCS (2005), pp. 595-604. S. Dughmi and T. Roughgarden, “Black-box randomized reductions in algorithmic mechanism design,” In FOCS (2010), pp. 775-784 indicate that packing problems that have an FPTAS solution may be turned into a truthful-in-expectation mechanism which is also an FPTAS.

Example techniques discussed herein utilize a single execution of the approximation algorithm, whereas conventional reductions have invoked the approximation algorithm many times, while providing only a polynomial bound on number of invocations.

A. Bar-Noy, et al., “Approximating the throughput of multiple machines in real-time scheduling,” SIAM Journal of Computing, 31(2) (2001), pp. 331-352, and C. A. Phillips, et al., “Off-line admission control for general scheduling problems,” In SODA (2000), pp. 879-888 consider variations of the interval-scheduling problem. These papers utilize a decomposition technique for their solutions.

According to example techniques discussed herein, a cloud provider may manage a cloud containing a fixed number of C servers. As another example, the cloud manager may allocate computing resources (e.g., central processing units (CPUs)) to computing jobs over time. The time axis may be divided into T time slots [symbol] ={1, 2, . . . , T}. For example, each of the time slots may represent an actual time interval of one hour.

According to an example embodiment, the cloud may have a capacity C represented in CPU hour units. The cloud provider receives requests from n users (clients), denoted by [symbol] ={1, 2, . . . , n}, where each user (client) has a computing job for execution. The cloud provider may choose to reject some of the job requests, for example, if allocating other computing jobs increases its profit. According to an example embodiment, the cloud may gain profit by fully completing a computing job.

Each computing job j may be described by a tuple [symbol] Dⱼ, kⱼ, vⱼ [symbol] . The first parameter Dⱼ, the demand of computing job j, may represent the total amount of demand units required to complete the computing job, where a demand unit may correspond to a single server being assigned to the computing job for a single time slot. Parallel execution of a computing job is allowed, that is, the computing job may be executed on several servers in parallel. Example techniques discussed herein may consider that the additional overhead due to parallelism is negligible. As discussed herein, parallel execution of a computing job may be limited by a threshold kⱼ, which may represent a maximal number of servers that may be assigned in parallel to computing job j, in a single time slot. Example techniques discussed herein may consider that

$$k {=}^{Δ} {max}_{j} \{ {k}_{j} \}$$

is substantially smaller than the total capacity C, i.e., k<<C.

As discussed herein, vⱼ: [symbol] →R^{+,0} may represent a valuation function of computing job j. That is, vⱼ(t) may denote the value gained by the owner of computing job j if computing job j is completed at time t. The valuation function vⱼ may be monotonically non-increasing in t. As discussed herein, a goal may include maximizing the sum of values of the computing jobs that are scheduled by the cloud. As discussed herein, at least deadline valuation functions and general valuation functions may be considered.

In a context of deadline valuation functions, users may be interested in their computing job being completed until a particular deadline (due date or due time). More formally, vⱼ(t) may denote a step function, which is equal to a constant scalar vⱼ until the deadline dⱼ, and 0 afterwards, which may be denoted as φⱼ=(vⱼ, dⱼ). Thus, users may value allocations based on the completion time of their computing job. According to an example embodiment, users may hold a private valuation function φⱼ:cₒ [symbol] → [symbol] ⁺ that represents the value the user gains as a function of the completion time of his/her computing job. Thus, φⱼ(t) may represent the value the user gains if the corresponding computing job is completed at time slot t ε [symbol] .

In a context of general valuation functions, the functions vⱼ(t) may represent monotonically non-increasing functions.

For simplicity of notation, when discussing the case of general valuation functions, dⱼ=T for each user. As discussed herein, [symbol] ={t ∈ [symbol] : t≦dⱼ} may denote a set of time slots in which computing job j can be executed and [symbol] ₜ={j ∈ [symbol] :t≦dⱼ} may denote the set of computing jobs that may be executed at time t.

As discussed herein, a mapping yⱼ: [symbol] ⱼ→[0, kⱼ] may denote an assignment of servers to computing job j per time unit, which does not violate the parallelism threshold kⱼ. A mapping which fully executes computing job j may be referred to as an allocation. More formally, an allocation aⱼ: [symbol] ⱼ→[0, kⱼ] may denote a mapping for computing job j with Σₜaⱼ(t)=Dⱼ. The set of allocations aⱼ which fully execute computing job j may be denoted by | [symbol] ⱼ|, and [symbol] =∪ⱼ₌₁ⁿ [symbol] ⱼ. Start and end times of a mapping yⱼ, respectively, may be denoted by s (yⱼ)=min {t:yⱼ(t)>0} and e (yⱼ)=max {t:yⱼ(t)>0}. As discussed herein, for an allocation aⱼ, e (aⱼ) may denote the time in which computing job j is completed when the computing job is allocated according to aⱼ, and yⱼ(e(aⱼ)) may denote the value gained by the owner of computing job j. As used herein, vⱼ(aⱼ) may indicate vⱼ(e(aⱼ)) to shorten notations.

The cloud may be allowed to complete a computing job prior to its deadline. However, preventing computing jobs from completing before their deadline may contribute to user truthfulness. For example, the cloud may artificially delay a completed computing job until its deadline. However, as discussed further herein, example techniques may be implemented such that each computing job actually finishes no earlier than its deadline. Such example techniques may be referenced as No Early Completion (NEC) techniques.

As used herein, the “cloud” may refer to a distributed network of computing devices (e.g., servers).

Lemma: Every feasible solution y of (LP) may be transformed to an equivalent feasible solution y′, such that x′=x and for every computing job j with x′ⱼ>0, e(y′ⱼ)=dⱼ.

Proof: An extra “idle” job representing the unallocated resources may be added. Thus, in every time slot, all of the C resources (CPU hours) are in use. If there were a computing job j that is completed before its deadline, d′ⱼ=e(yⱼ)<dⱼ may represent the completion time of computing job j. Thus, ∃ a computing job i with yᵢ (d′ⱼ)<yᵢ(dⱼ), since every time slot is full and yⱼ(d′ⱼ)>yⱼ(dⱼ).

Swap between computing jobs j and i as follows: a small number δ>0 may be obtained, yⱼ(d′ⱼ) and yᵢ(dⱼ) may be decreased by δ, and yⱼ(dⱼ) and yᵢ(d′ⱼ) may be increased by δ (xⱼ and x_{j′} do not change). By choosing δ≦min {yⱼ(e(yⱼ)), y′ⱼ(dⱼ)−y′ⱼ (e(yⱼ))} no parallelism constraint is violated. Swapping is continued until the desired solution y′ is obtained.

Example techniques discussed herein include an example algorithm for BFS that approximates the social welfare, i.e., the sum of values gained by the users. Example techniques discussed herein may consider that users bid truthfully. An example technique discussed herein may include a payment scheme that provides no incentive for users to bid untruthfully.

An LP relaxation for the case of deadline valuation functions is discussed further below, as is a canonical solution form in which all mappings are Monotone non Decreasing (MND) mappings. As discussed further below, this result may be generalized to the case of general valuation functions. Further, an example decomposition algorithm which yields an α-approximation to the optimal social welfare of BFS is discussed below.

An example integer program (IP) may be considered. A variable yⱼ(t) for t ∈ Tⱼ in (IP) may denote the number of servers assigned to j at time t. As discuss herein, yⱼ may denote the mapping induced by the variables {yⱼ(t)}ₜ ∈ Tⱼ and xⱼ may denote a binary variable indicating whether computing job j has been fully allocated or not at all.

(IP) max Σⱼ₌₁ⁿvⱼxⱼ

s.t. Σ_{t∈T}_{ⱼ}yⱼ(t)=Dⱼ·xⱼ ∀ j ∈ J (1)

Σ_{j∈J}_{ₜ}yⱼ(t)≦C ∀ t ∈ T (2)

0≦yⱼ(t)≦kⱼ ∀ j ∈ J, t ∈ T (3)

xⱼ∈ {0, 1} ∀ j ∈ J (4)

Equations (1), (2) and (3) denote job demand, capacity and parallelization constraints.

As discussed herein, the constraints xⱼ ∈ {0, 1} may be “relaxed” to 0≦xⱼ≦1 for every j ∈ [symbol] to achieve a fractional upper bound on the optimal social welfare. However, the integrality gap of the resulting linear program may be as high as Ω(n). For example, the following instance may be considered: A service may receive nC computing jobs with kⱼ=1 for every computing job j which are divided into n sets S₀, . . . , Sₙ₋₁, each of size C. A computing job j ∈ Sᵢ requests Dⱼ=2ⁱ demand units which for completion before time 2ⁱ. Formally, vⱼ=1 and dⱼ=2ⁱ. An optimal integral solution may gain at most C, since any completed job receives a demand unit at time t=1. Yet, the optimal fractional solution gains

$$C + \frac{C \cdot ( n - 1 )}{2}$$

by mapping the computing jobs as follows: For computing jobs j ∈ S₀, set yⱼ(1)=1, thus completing them fully. For computing jobs j ∈ Sᵢ with i≧1, set yⱼ(t)=1 for t ∈ (2ⁱ⁻¹, 2ⁱ] and yⱼ(t)=0 otherwise, and by that, half of computing job j may be completed before t=2ⁱ.

Thus, Equation (5) may be added to the linear program:

yⱼ(t)≦kⱼxⱼ ∀ j ∈ [symbol] t ∈ [symbol] (5)

Such constraints may aid in avoidance of undesirable mappings which do not correspond to feasible allocations. For example, for the example discussed above, the mappings of computing jobs j ∈ Sᵢ for i≧1 may violate Equation (5), since for t ∈ (2ⁱ⁻¹, 2ⁱ], yⱼ(t)=1, yet xⱼ=½. Such mappings may not be extended to feasible allocations. That is, if the mapping yⱼ is extended (disregarding capacity constraints) by dividing every entry in yⱼ by xⱼ, the parallelization threshold of computing job j is exceeded. As discussed herein, the linear program, including the constraints in (5), may be referenced as (LP-D).

As discussed herein, an example monotonically non-decreasing (MND) mapping (allocation) yⱼ: [symbol] ⱼ→[0, kⱼ] may denote a mapping (allocation) which is monotonically non-decreasing in the interval [s (yⱼ, e (yⱼ)].

As discussed herein, (MND-LP-D) may denote a configuration LP with all allocations in [symbol] restricted to be MND allocations. Unlike (CONF-LP-D), which may be represented as (LP-D), (MND-LP-D) does not have an equivalent formulation which directly solves it. As discussed herein, (MND-LP-D) may be optimized by first solving (LP-D) and then applying a reallocation algorithm that converts any solution of (LP-D) to a solution with all mappings being MND mappings, without decreasing the social welfare of the original solution.

As discussed further herein, the optimal social welfare of (LP-D) and (MND-LP-D) are equal. Moreover, there exists a poly(n, T) time algorithm that converts an optimal solution of (LP-D) to an optimal solution of (MND-LP-D).

The equivalence between both linear programs is a result of the following reallocation algorithm. Let y be a feasible solution to (LP-D). To simplify discussion, an additional “idle” job may be added which is allocated whenever there are free servers. Thus, in every time slot, all C servers are in use. As discussed further below, a reallocation algorithm may transform the mappings in y to MND mappings. For example, the reallocation algorithm may swap between assignments of computing jobs to servers, without changing the completed fraction of every computing job (xⱼ), such that no completion time of a computing job will be delayed. Since the valuation functions are deadline valuation functions, the social welfare of the resulting solution may be equal to the social welfare matching y. Specifically, an optimal solution to (LP-D) will remain optimal.

An example Algorithm 1 as shown below more formally illustrates example steps that may be performed for an example reallocation technique. One skilled in the art of data processing will understand, however, that many other techniques may be used for reallocation, without departing from the spirit of the discussion herein.

Algorithm 1
Algorithm 1: Reallocation

Reallocate(y)

| | |
|---|---|
| 1. | While y includes non-MND mappings. |
| 1.1 | Let j be a job generating a maximal(a,b)-violation according to [symbol] . |
| 1.2 | ReallocationStep(y, j, a, b). |

ReallocationStep(y, j, a, b)

| | |
|---|---|
| 1. | Let j′ be a job such that y_{j′} (a) < yⱼ^{_{′}} (b) |
| 2. | [symbol] max = max {t ∈ [a, b] : y_{j′}(t) = y_{j′}(b)} |
| 3. | δ = max {y_{j′}(t) : t ∈ [ab] \ [symbol] ₘₐₓ } |
| 4. | $Δ = min \{ \frac{{y}_{j} ( a ) - {y}_{j} ( b )}{1 + \vert {T}_{max} \vert} , \frac{{y}_{{j}^{′}} ( a ) - {y}_{{j}^{′}} ( b )}{1 + \vert {T}_{max} \vert} , {y}_{{j}^{′}} ( b ) - δ \}$ |
| 5. | Reallocate as follows: |
| 5.1. | y_{j′}(t) ← y_{j′}(t) − Δ for every t ∈ [symbol] ₘₐₓ |
| 5.2. | y_{j′}(a) ← y_{j′}(a) + Δ · \| [symbol] ₘₐₓ\|·\| [symbol] ₘₐₓ\| |
| 5.3. | yⱼ(a) ← yⱼ(a) − Δ · \| [symbol] ₘₐₓ\| |
| 5.4. | yⱼ(t) ← yⱼ(t) + Δ for every t ∈ [symbol] ₘₐₓ |

As discussed herein, A_{y}(t)={j:yⱼ(t)>0} may denote a set of computing jobs active at time t in y.

As discussed herein, a computing job j ∈ [symbol] (b) may generate an (a, b)-violation if a<b and yⱼ (a)>yᵢ(b). Violations may be ordered according to a binary relation [symbol] over [symbol] × [symbol] , such that:

(a, b) [symbol] (a′, b′) [symbol] b<b′ or (b=b′) [symbol] (a≦a′) (6)

As discussed herein, a goal associated with a solution y to (LP-D), may include elimination of (a, b)-violations in y and consequently remaining with only MND mappings, keeping y a feasible solution to (LP-D).

According to an example embodiment, the reallocation algorithm may include the following features: In every step, the algorithm may attempt to eliminate a maximal (a, b)-violation, according to the order induced by [symbol] . As discussed herein, j may denote the computing job generating this maximal (a, b)-violation. Thus, there exists some computing job j′ with yⱼ(a)<yⱼ(b), since in every time slot all C servers are in use. A reallocation step may be applied, which attempts to eliminate this violation by shifting workload of computing job j from a to later time slots (e.g., to b), and by doing the opposite to j. For example, yⱼ may be increased in time slots in [symbol] ₘₐₓ, as shown in line 2, by a value Δ>0 set later, and y_{y′}(a) may be increased by the amount that is decreased from other variables. For example, if yⱼ is not decreased for time slots in [symbol] ₘₐₓ, (ã, b)-violations for a <ã may be generated, and the reallocation algorithm may not stop.

According to an example embodiment, Δ may be selected such that after calling the reallocation step, either: (1) yⱼ(a)=yⱼ(b), (2) yⱼ(a)=yⱼ(b), or (3) the size of [symbol] ₘₐₓ increases. In the second case, if the (a, b)-violation has not been resolved, then there exists a different computing job j″ ∈ [symbol] _{y}(b) with y_{j″}(a)<y_{j″}(b), and therefore the reallocation step may be called again. In the third case, [symbol] ₘₐₓ may be expanded and Δ may be recalculated. According to an example embodiment, the reallocation algorithm may repeatedly apply the reallocation step, choosing the maximal (a, b)-violation under until [symbol] , all mappings become MND mappings.

As discussed herein, y may denote a feasible solution of (LP-D) and j may denote a computing job generating a maximal (a, b)-violation over [symbol] . As discussed herein, \tilde{y} may denote the vector y after calling ReallocationStep (y,j, a, b) and (ã, \tilde{b}) may denote the maximal violation in \tilde{y} over [symbol] . Then:
1. \tilde{y} is a feasible solution of (LP-D).
2. (ã, \tilde{b}) [symbol] (a, b)
3. No new (a, b)-violations are added to \tilde{y}.

As discussed herein, yⱼ, \tilde{y}ⱼ may denote the mappings of j before and after the reallocation step, and y_{j′}, \tilde{y}_{j′} may be denoted similarly. By the choice of (a, b), for every t ∈ (a, b] there is no (t, b)-violation and thus:

∀ t ∈(a,b] yⱼ(t)≦yⱼ(b) (7)

∀ t ∈(a,b] y_{j′}(t)≦y_{j′}(b) (8)

By the construction of the reallocation step, since is reduced by Δ for every time slot in [symbol] ₘₐₓ and since the reallocation is halted when one of the strong inequalities reach equality or when the size of [symbol] ₘₐₓ increases:

∀ t ∈ [a,b] \tilde{y}ⱼ(t)≦\tilde{y}ⱼ(a) (9)

∀ t ∈ [a, b] \tilde{y}_{j′}(t)≦\tilde{y}_{j′}(b) (10)

The reallocation step may decrease yⱼ(a), y_{j′} (b) and keep xⱼ, x_{j′}, fixed, thus both j, j′ may not violate any constraint of type (5) in \tilde{y}, which may prove \tilde{y} is a feasible solution of (LP-D) since the example technique started with a feasible solution of (LP-D).

By the maximality of (a, b) and since yⱼ(a), y_{j′}(b) are upper bounds on the entries of \tilde{y}ⱼ, \tilde{y}_{j′} in [a, b], no (ã, \tilde{b})-violation for b<\tilde{b} is generated. By Equation (10), j^{′} does not generate an (ã, b)-violation for a<ã. Since b ∈ [symbol] ₘₐₓ and by (7), the same goes for j, proving (ã, \tilde{b}) [symbol] (a, b) and No new (a, b)-violations are added to \tilde{y}.

As discussed herein, a reallocation step may be implemented in polynomial time, and resolving an (a, b)-violation may be accomplished via at most nT reallocation steps.

As discussed herein, OPT*, OPT*_{MND} may denote the optimal solutions of (LP-D),(MND-LP-D) respectively. Each feasible solution to (MND-LP-D) is a feasible solution to (LP-D), and thus OPT*≧OPT*_{MND}. If y* denotes an optimal solution to (LP-D), a feasible solution to (MND-LP-D) may be achieved by applying the reallocation algorithm on y*. As discussed herein, the social welfare does not change after applying the reallocation algorithm, since every valuation function vⱼ is a deadline valuation function. Thus, OPT*≦OPT*_{MND}.

To illustrate that the reallocation algorithm may converge in poly(n, T) time, a potential function may be considered which denotes the total number of violations. The reallocation algorithm may resolve at least one violation after at most nT calls to the reallocation step. Since the maximal initial number of such violations is bounded by O (nT³) (for deadline valuation functions, the bound is O (nT²)), \tilde{y} is a feasible solution of (LP-D), b) (ã, \tilde{b}) [symbol] (a, b), and no new (a, b)-violations are added to \tilde{y}.

The linear program for the case of general valuation functions may be similar in spirit to the one described for deadline valuation functions. As discussed further herein, a fractional solution may induce a distribution over end times. To maintain a low integrality gap, each end time may be associated with a mapping corresponding to a feasible allocation, as discussed above. According to an example embodiment, every user may be split into T subusers, one for each end time, each associated with a deadline valuation function.

More formally, each user j may be substituted by T subusers j¹, j², . . . , j^{T}, all with the same demand and parallelization threshold as j. For ease of notation, yⱼ^{e}(t) may denote the variables in the linear program matching subuser j^{e}, and similar superscript notations may be used herein. For every subuser j^{e}, set vⱼ^{e}=vⱼ(e) and dⱼ^{e}=e. An additional set of constraints may be added, thus limiting the distribution of j over end times to 1:

Σ_{e∈T}xⱼ^{e}≦1 ∀ j ∈ [symbol] (11)

As discussed herein, each integral solution to BFS is a feasible solution to this relaxed linear program: A computing job j allocated according to an allocation aⱼ matches the subuser j^{e(a}^{ⱼ}⁾. As discussed herein, the reallocation algorithm may be applied, transforming mappings of subusers to be MND mappings. The reallocation algorithm does not change the values xⱼ^{e}, thus it will not cause violations in accordance with Equation (11). As discussed herein, these results may be extended to cases wherein valuation functions are non-monotone.

As discussed herein, (LP) may be referred to the relaxed linear program for general valuation functions, after adding Equations (5) and (11), and (MND-LP) may refer to the matching configuration LP with MND allocations. When applying results to deadline valuation functions settings, every user j may be viewed as a single subuser j^{d}^{ⱼ}.

As discussed herein, an example approximation algorithm as discussed below, may generate a set of feasible solutions to BFS based on a fractional optimal solution to (LP) given in the canonical MND form. Example coloring algorithms for the weighted job interval scheduling problem are discussed in A. Bar-Noy, et al., “Approximating the throughput of multiple machines in real-time scheduling,” SIAM Journal of Computing, 31(2) (2001), pp. 331-352, and C. A. Phillips, et al., “Off-line admission control for general scheduling problems,” In SODA (2000), pp. 879-888.

For example, a first step of the algorithm may generate a multiset S ⊂ ∪ⱼ₌₁ⁿAⱼ of allocations based on an optimal solution of (MND-LP), and then the allocations in S may be divided into a set of feasible solutions to BFS.

According to an example embodiment herein, a first step may generate S as follows:

Step I: N may denote a large number (as discussed further herein). A computing job j may be substituted by a set of subusers j¹, j², . . . , j^{T} (or a single subuser j^{d}^{ⱼ} for a case of deadline valuation functions). As discussed herein, y may denote an optimal solution of (LP) after applying the reallocation algorithm. For each subuser j^{e}, aⱼ^{e} may denote the allocation corresponding to yⱼ^{e}, as follows:

$${a}_{j}^{e} ( t ) = \frac{{y}_{j}^{e} ( t )}{{x}_{j}^{e}} ∀ t ∈ {𝒯}_{j} \qquad ( 12 )$$

As discussed herein, aⱼ^{e} may denote an allocation by the definition of xⱼ^{e} and by Equation (5). As discussed herein, z may denote the vector representing the values xⱼ^{e}, that is, z (a)=xⱼ^{e} if a=aⱼ^{e} for some subuser j^{e} and z (a)=0 otherwise. As discussed herein, the social welfare of fractionally allocating computing jobs according to y* may be denoted as OPT*=Σⱼ_{^{e}}vⱼ(aⱼ^{e})·z(aⱼ^{e}). As discussed herein, z̅ may denote the vector z with entries rounded up to the nearest integer multiplication of

$$\frac{1}{N} .$$

According to an example embodiment, [symbol] may be generated as: ∀ subuser j^{e}, add N· z̅(aⱼ^{e}) copies of xⱼ^{e} to S.

According to an example embodiment herein, a second step may generate colorings of allocations as follows:

Step II: Coloring Allocations. According to an example embodiment, the coloring algorithm may color copies of MND allocations in S such that any set of allocations with a same color will induce a feasible integral solution to BFS. For example, 1, 2, . . . , COL may denote the set of colors used by the coloring algorithm. As discussed herein, a ∈ c may indicate that an allocation a is colored in color c. For a color c, c (t)=Σ_{a∈c}a(t) may denote the total load of MND allocations colored in c at time t.

An example Algorithm 2 as shown below more formally illustrates example steps that may be performed for an example coloring technique. One skilled in the art of data processing will understand, however, that many other techniques may be used for such coloring, without departing from the spirit of the discussion herein.

Algorithm 2
Algorithm 2: Coloring Algorithm (S)

1. Sort the MND allocations a ε S according to e (a) in descending
order.
2. For every MND allocation a in this order
2.1. Color a in some color c such that c remains a feasible integral
solution.

As discussed below, the number of colors used may be relatively small, such that an example α-approximation algorithm may be utilized.

As discussed herein, an iteration after some allocation a ∈ S is colored may be considered. Then, for every color c, c (t) is monotonically non-decreasing in the range [1, e(a)].

According to an example embodiment, an inductive technique may be used to illustrate that, for every color c, c (t) is monotonically nondecreasing in the range [1, e(a)]. Initially, ∀t, c (t)=0 for every color c. An iteration may be considered wherein a is colored. By the induction hypothesis (above), c (t) is monotonically nondecreasing for every color c in the range [1, e (a)] (the induction hypothesis may imply that c (t) is monotonically nondecreasing for a larger range). Since a is an MND allocation, coloring a with some color c may maintain a status that c(t) is non decreasing in [1, e(a)].

As discussed herein, the coloring algorithm may succeed when

$$COL = N \cdot ( 1 + \frac{C}{C - k} ) ( 1 + \frac{nT}{N} ) .$$

As illustration, it may be shown that when coloring an MND allocation, there exists a free color. According to an example embodiment, an iteration of the coloring algorithm may be considered wherein an allocation a ∈ Aⱼ is colored. The number of allocations in S ∩Aⱼ other than a is at most

$$N \cdot ( 1 + \frac{T}{N} ) - 1 ,$$

since the number of different allocations corresponding to j is at most T (the number of subusers), and therefore this is the maximal number of colors which may not be used due to collision between allocations matching the same computing job. According to an example embodiment, a color c may be considered in which a may not be colored due to capacity constraints. By the monotonicity of both c (t) and a, c (e (a))≧C−kⱼ≧C−k. The total workload of instances in S at any time t may be at most:

$$N \cdot {\sum }_{{j}^{e}} {a}_{j}^{e} ( t ) \cdot \overline{z} ( {a}_{j}^{e} ) \leq N \cdot {\sum }_{{j}^{e}} {a}_{j}^{e} ( t ) \cdot ( a ( {a}_{j}^{e} ) + \frac{1}{N} ) \leq CN + knT \leq CN \cdot ( 1 + \frac{nT}{N} ) \qquad ( 13 )$$

since aⱼ^{e} (t)≦k for every j^{e}, t. Thus, the number of such colors may be at most

$$\frac{CN}{C - k} ( 1 + \frac{nT}{N} ) .$$

As discussed further herein, there may exist a poly

$$( n , T , \frac{1}{ɛ} )$$

time approximation algorithm that, given an optimal solution to (LP), returns an α-approximation to the BFS problem ∀ ε≦0.

According to an example embodiment, y* may denote an optimal solution of (LP) after application of the reallocation algorithm, and OPT* may denote the optimal social welfare matching y*. According to an example embodiment, construct a multiset S may be generated as discussed in Step I (above) and S may be decomposed into COL solutions for BFS according to Step II (above), with a total value of:

N·Σⱼ_{^{e}}vⱼ(aⱼ^{e})· z̅(aⱼ^{e})≧N19 OPT* (14)

According to an example embodiment, N may be determined as

$$N = \frac{nT}{ɛ}$$

(and thus, COL=Nα). As discussed herein, the running time of the coloring algorithm may be polynomially bounded by n, N, T and thus polynomially bounded by n, T,

$$\frac{1}{ɛ} .$$

According to an example embodiment, the algorithm may allocate computing jobs in accordance with allocations colored by a favorable color c, based on social welfare. According to an example embodiment, Alg may denote the social welfare gained by this algorithm. Since

$$Alg \geq \frac{N \cdot {OPT}^{*}}{COL} = \frac{{OPT}^{*}}{α} , \qquad ( 15 )$$

the example technique may determine an α-approximation. According to an example embodiment, for deadline valuation functions, by applying similar techniques, it may be illustrated that N may be determined as

$$N = \frac{n}{ɛ} .$$

According to an example embodiment, an example configuration LP for BFS may be illustrated as discussed further below.

According to an example embodiment, ∀ job j and V allocation aⱼ ∈ Aⱼ a variable zⱼ (aⱼ) may indicate whether computing job j has been fully allocated according to aⱼ (or not). As discussed herein, the configuration LP may be denoted as follows:

max Σⱼ₌₁ⁿΣₐ_{ⱼ}_{∈ A}_{ⱼ}vⱼ·zⱼ(aⱼ) (CONF-LP-D)

s.t. Σₐ_{ⱼ}_{∈ A}_{ⱼ}zⱼ(aⱼ)≦1 ∀ j ∈ [symbol] (16)

Σ_{j∈J}Σₐ_{ⱼ}_{∈ A}_{ⱼ}_{∩J}_{ₜ}aⱼ(t)·zⱼ(aⱼ)≦C ∀ t ∈ [symbol] (17)

zⱼ(aⱼ)≧0 ∀ j ∈ [symbol] , aⱼ ∈ Aⱼ (18)

As discussed herein, Equation (16) may indicate an ability to select at most one allocation per computing job and Equation (17) may correspond to capacity constraints. According to an example embodiment, since allocations may be defined over the real numbers, the number of allocations in a set Aⱼ may be uncountable. As discussed below, (LP-D), is may be effectively utilized to obtain a representation of (CONF-LP-D).

As discussed further below, it may be illustrated that the optimal social welfare of (LP-D) and (CONF-LP-D) may be equal.

For example, a solution y of the relaxed linear program may be considered. As discussed herein,

$${x}_{j} = \frac{1}{{D}_{j}} {\sum }_{t} {y}_{j} ( t ) .$$

For each computing job j an allocation aⱼ matching the values {yⱼ(t)} may be determined based on setting

$${a}_{j} ( t ) = \frac{{y}_{j} ( t )}{{x}_{j}} .$$

This may provide a feasible allocation, since Σₜ aⱼ(t)=Dⱼ and aⱼ(t)≦kⱼ ∀ t ∈ [symbol] by Equation (5). The example illustration may further set zⱼ(aⱼ)=xⱼ and zⱼ(a)=0 ∀ a ∈ Aⱼ\ {aⱼ}. Thus, z is a feasible solution of the configuration LP.

In an opposing direction, a solution z of the configuration LP may be considered. For each t ∈ [symbol] , set:

$${a}_{j} ( t ) = \frac{{\sum }_{a ∈ {A}_{j}} {z}_{j} ( a ) \cdot a ( t )}{{z}_{j} ( {a}_{j} )} \qquad ( 19 )$$

wherein zⱼ(aⱼ)=Σ_{a∈ A}_{ⱼ}zⱼ(a). According to an example embodiment, aⱼ is a feasible allocation, since aⱼ(t)≦kⱼ for every t ∈ [symbol] ⱼ and since:

$$\begin{matrix}{\sum }_{t ∈ {T}_{j}} {a}_{j} ( t ) = \frac{{\sum }_{t ∈ {T}_{j}} {\sum }_{a ∈ {A}_{j}} {z}_{j} ( a ) \cdot a ( t )}{{z}_{j} ( {a}_{j} )} \\ = \frac{{\sum }_{α ∈ {A}_{j}} {z}_{j} ( a ) \cdot {\sum }_{t ∈ {T}_{j}} a ( t )}{{z}_{j} ( {a}_{j} )} = {D}_{j}\end{matrix} \qquad ( 20 )$$

In accordance with example features associated with aⱼ, the total capacity consumed by aⱼ may be equal to the capacity consumed by allocations according to z. Further, the contribution of aⱼ to the objective function is the sum of contributions by allocations in Aⱼ. Thus, aⱼ may be translated to its matching vector yⱼ by setting yⱼ(t)=aⱼ(t)·zⱼ(aⱼ)∀ t ∈ [symbol] ⱼ.

As discussed above, users may report their true valuation functions to a cloud provider and prices may be charged accordingly. However, users may act rationally and thus may choose to untruthfully report a valuation function bⱼ which differs from their true valuation function vⱼ if they may gain from it.

According to an example embodiment, an example technique may charge costs from users such that reporting their valuation function untruthfully may not benefit them. According to an example embodiment, the approximation algorithm may be called once, providing efficiency to the example technique.

In accordance with mechanism design, each participating user may choose a type from a predetermined type space. According to an example embodiment, a user may choose a valuation function vⱼ from a set of monotonically non-increasing valuation functions (or deadline valuation functions) to represent the user's true type. As discussed herein, Vⱼ may denote the set of types from which a user j may choose, with V denoting V=V₁× . . . ×Vₙ. For a vector v, v₋ⱼ may denote the vector v restricted to entries of users other than user j and Vⱼ may be indicated similarly. As discussed herein, O may denote a set of all possible outcomes of the example mechanism. As discussed herein, vⱼ may be extended to accept inputs from O. More formally, vⱼ(o) for o ∈ O may thus represent the value gained by user j under outcome o.

More formally, a mechanism [symbol] =(ƒ, p) may include an allocation rule f: V→O and a pricing rule pⱼ:V→ [symbol] for each user j. Users may report a bid type bⱼ ∈ Vⱼ to the mechanism, which may be different from their true type vⱼ. The mechanism, given a reported type vector b=(b ₁, . . . , bₙ) computes an outcome o=ƒ(b) and charges pⱼ(b) from each user. Each user may strive to maximize its utility, which may be denoted as:

uⱼ(b)=vⱼ(o)−pⱼ(b) (21)

where oⱼ may denote the allocation according to which computing job j is allocated (if at all). Such example mechanisms, wherein the valuation function does not map to a single scalar, may be referred to as multi-parameter mechanisms. According to an example embodiment, a multi-parameter mechanism may be determined wherein users may benefit by declaring their true type.

As used herein, a deterministic mechanism is truthful if for any user j, reporting its true type maximizes uⱼ(b). Thus, for a bid bⱼ ∈ Vⱼ and a v₋ⱼ ∈ V₋ⱼ:

uⱼ((vⱼ,v₋ⱼ))≧uⱼ((bⱼ,v₋ⱼ)) (22)

where vⱼ ∈ Vⱼ may denote the true type of user j.

As used herein, a randomized mechanism is truthful-in-expectation if for any user j, reporting its true type maximizes the expected value of uⱼ (b). Thus, Equation (22) holds in expectation.

As used herein, a mechanism is individually rational (IR) if uⱼ (v) does not receive negative values for every j. Thus, non-allocated users may be charged 0.

As discussed further below, a truthful-in-expectation mechanism for the BFS problem may be constructed based on a truthful mechanism that may fractionally allocate computing jobs.

A truthful, individually rational mechanism may return a fractional feasible allocation, that is, allocate fractions of computing jobs according to (LP). An example fractional mechanism may be described as follows:

Given reported types bⱼ: [symbol] → [symbol] ^{1,0}, solve (LP) and obtain an optimal solution y*. Let o ∈ O denote the outcome matching y* and let OPT* denote the social welfare when computing jobs are allocated according to y*.

Charge Pⱼ(z)=hⱼ(o₋ⱼ)−Σ_{i≠j}bᵢ(oᵢ) from every user j, where hⱼ may denote any function independent of oⱼ.

This mechanism may be referred to as the VCG (e.g., Vickrey-Clarke-Groves) mechanism. As discussed herein, (LP) may maximize the social welfare, i.e., the sum of values gained by all users. Users may gain gⱼ(v)=OPT* −hⱼ₍o₋ⱼ₎ by bidding truthfully and therefore the mechanism is optimal, since deviating may decrease Σᵢvᵢ(o). By dividing both valuation functions and charged prices by a constant, the fractional VCG mechanism may remain truthful. Individual rationality of the fractional VCG mechanism may be obtained by setting the functions hⱼ in accordance with an example Clarke pivot rule.

R. Lavi et al., “Truthful and near-optimal mechanism design via linear programming,” In FOCS (2005), pp. 595-604 provides a black-box reduction for combinatorial auction packing problems based on generating a truthful-in-expectation mechanism to determining an approximation algorithm A that verifies an integrality gap of the “natural” LP for the problem. Their mechanism may provide a β-approximation to the optimal social welfare, where β is a bound of the integrality gap obtained by A, based on determining a decomposition of

$$\frac{{z}^{*}}{β} ,$$

where z* may denote the optimal fractional solution of the “natural” LP, into a distribution over feasible integral solutions.

According to an example embodiment, by drawing a solution from this distribution and charging prices of

$$\frac{{p}_{j}}{β} ,$$

a truthful-in-expectation mechanism may be obtained, as the expected utility of users equals their utility in the fractional VCG mechanism.

R. Lavi et al., supra, also indicate prices such that the truthful-in-expectation mechanism may be individually rational. However, the approximation algorithm A is used as a separation oracle for an additional linear program used as part of the reduction by R. Lavi et al., supra.

According to an example embodiment, an example approximation algorithm as discussed herein, may be called only once.

According to an example embodiment herein, S^{c} may denote the solution to BFS matching color c and z^{c} may denote a binary indicator vector of S^{c} (z^{c} (a)=1 iff a ∈ S^{c}). According to an example embodiment herein, the vector z may be rounded up to integer multiplications of

$$\frac{1}{N}$$

and then

$$\frac{\overline{z}}{a}$$

may be decomposed, when generating S. Thus:

$$\frac{1}{COL} \cdot {\sum }_{C = 1}^{COL} {z}^{C} = \frac{\overline{z}}{α} \geq \frac{z}{α} \qquad ( 23 )$$

As discussed above, z may denote the vector matching the optimal solution of (LP) and COL=N_{α}. According to an example embodiment, an example alternative technique may be used to round the entries in z to integer multiplications of

$$\frac{1}{N} .$$

According to an example embodiment, a vector \tilde{z} may be generated with [symbol] [\tilde{z}(a)=z (a) ∀ a ∈ A as follows:

Assuming that

$$z ( a ) = \frac{q ( a )}{N} + r ( a ) for q ( a ) ∈ N and 0 \leq r ( a ) < \frac{1}{N} , set \tilde{z} ( a ) = \frac{q ( a ) + 1}{N}$$

with probability N·r (a), and

$$\tilde{z} ( a ) = \frac{q ( a )}{N}$$

otherwise. As discussed herein, [symbol] ][\tilde{z}(a)]=z (a) as desired.

S may be generated based on \tilde{z}, and the coloring algorithm discussed above may be called. Thus:

$$\frac{1}{COL} \cdot 𝔼 [ {\sum }_{C = 1}^{COL} {Z}^{C} ] = 𝔼 [ \frac{\overline{z}}{α} ] = \frac{z}{α} \qquad ( 24 )$$

According to an example embodiment, one of the solutions S¹, S², . . . , S^{COL} may be drawn uniformly and allocations may be determined based on the solution. As discussed herein, the expected social welfare may have a value that is at least

$$\frac{1}{α}$$

times the optimal social welfare.

According to an example embodiment, a Decompose-Relaxation-and-Draw (DRD) technique may be used for fully allocated computing jobs. An example Algorithm 3 as shown below more formally illustrates example steps that may be performed for an example DRD technique.

Algorithm 3
Algorithm 3: Decompose-Relaxation-and-Draw (DRD)

Data: Parameter ε > 0

| | |
|---|---|
| 1. | $initialize parameters \text{:} N ← \frac{n}{ɛ} \cdot α = ( 1 + \frac{C}{C - k} ) ( 1 + ɛ ) , SOL = N α .$ |
| 2. | initialize an empty set S ← φ of job allocations. |
| 3. | find an optimal fractional solution y* to (LP) given in MND form. |
| 4. | $define \text{:} {x}_{j}^{*} ← \frac{1}{{D}_{j}} {\sum }_{t \leq {d}_{j}} {y}_{j}^{*} ( t ) .$ |
| 5. | $set \text{:} {P}_{j} ← N ( {x}_{j}^{*} - ⌊ \frac{{x}_{j}^{*}}{N} ⌋ )$ |
| 6. | for each job I |
| 6.1. | let aⱼ be the allocation defined by aⱼ (t) = yⱼ* (t) / xⱼ* ∀ t ≦ dⱼ. |
| 6.2. | $with probability {P}_{j} , add N ⌊ \frac{{x}_{j}^{*}}{N} ⌋ copies of {a}_{j} to S .$ |
| 6.3. | $otherwise , add N ⌈ \frac{{x}_{j}^{*}}{N} ⌉ copies of {a}_{j} to S .$ |
| 7. | sort the allocations in S according to e (aⱼ) in descending order. |
| 8. | set SOL empty solutions to (LP): S¹, S², . . . , S^{SOL}. |
| 9. | for each copy aⱼ ∈ S according to the ordering of 6. |
| 9.1. | add aⱼ to a solution S^{c} such that: |
| | - S^{c} does not include any other copy corresponding to job j |
| | - adding aⱼ to S^{c} does not violate a capacity constraint. |
| 10. | draw one of the SOL solutions Sc uniformly at random. |
| 11. | allocate according to S^{c}. |
| 12. | let pⱼ (b) be the payments defined by VCG. |
| 13. | charge pⱼ (b)/ xⱼ* from every allocated job, charge 0 otherwise. |

As shown in Algorithm 3, an optimal fractional solution y*, in MDF form, may be decomposed (lines 3-6) into a multiset S of allocations. For each computing job j an allocation aⱼ may be generated by dividing every entry of the mapping y_{j′} by x_{j′}. The allocation aⱼ does not violate the parallelism bound of computing job j. The number of copies and the probabilities Pⱼ (lines 5, 6.1, 6.2) may be chosen such that the expected number of copies for every computing job j is Nxⱼ*. Thus, the expected total value of allocations in S is N·OPT.

In a next step, the copies of allocations in S are divided (lines 7-9) into a set of SOL=Nα feasible solutions, i.e., a solution may include at most one copy for each computing job and does not violate the capacity constraints.

One of the solutions may then be uniformly drawn and returned (lines 10-11). The probability of computing job j being allocated is

$$\frac{{Nx}_{j}}{SOL} = \frac{{x}_{j}^{*}}{α} .$$

The expected value gained by user j is

$$\frac{{v}_{j} {x}_{j}^{*}}{α}$$

and therefore Algorithm 3 provides an α-approximation to the optimal social welfare.

The expected payment charged from user j is

$$\frac{{p}_{j} ( b )}{α}$$

(lines 12-13). Thus, the expected utility of a user is the utility gained by the user in the fractional VCG technique, scaled down by a factor of α, which is constant.

An example Algorithm 4 as shown below more formally illustrates example steps that may be performed for an example Full-By-Relaxation (FBR) technique.

Algorithm 4
Algorithm 4: Full-By-Relaxation (FBR)

1. Find a basic optimal fractional solution y* to (LP) and transform it to
NEC form.
2. Set yⱼ* (t) = 0 for every job j with xⱼ* < 1.
3. Allocate jobs according to y*: fⱼ(b) = 1 [symbol] xⱼ* = 1.
4. Set payments pⱼ(b) in accordance with
pⱼ(b) = vⱼ′fⱼ(vⱼ′, dⱼ′) − ∫ₒ^{v}ⱼ′ fⱼ(s, dⱼ′) ds, as discussed herein

As shown in Algorithm 4, the allocation algorithm of the FBR technique is based on the linear program (LP) discussed herein. According to an example embodiment, the FBR technique may schedule computing jobs that are fully allocated according to the optimal fractional solution of (LP). More formally, given a bid vector b=(b₁, b₂, . . . , bₙ) of deadline valuation functions, a basic optimal fractional solution y of (LP) may be determined. The resources that were allocated to computing jobs that were not completed according to y may then be released.

According to an example embodiment, the optimal fractional solution is basic, in order to increase the number of fully allocated computing jobs. For example, two identical computing jobs may request the same resources. A basic solution may fully allocate one of them, whereas a non-basic solution may allocate any convex combination of them (e.g., 30% and 70%).

According to an example embodiment, the allocation algorithm may complete scheduled computing jobs by their reported deadline (according to an example transformation discussed herein).

As used herein, an allocation function ƒ is value-monotonic if ∀ deadline dⱼ, φ₋ⱼ and ∀ C, vⱼ″, vⱼ′≦vⱼ″.

ƒⱼ(vⱼ′, dⱼ)≦ƒⱼ(vⱼ″, dⱼ) (25)

A single-parameter mechanism [symbol] (ƒ, P) is value-truthful iff ƒ is value-monotonic. In this case, the payments are of the following form, wherein the bid of user j may be denoted as bⱼ=(vⱼ′, d′ⱼ):

pⱼ(b)=vⱼ′ƒⱼ(vⱼ′, dⱼ′)−∫₀^{v}^{ⱼ}^{′}ƒⱼ(s, dⱼ′)ds (26)

As used herein, an allocation function ƒ is deadline-monotonic if ∀ value vⱼ, φ₋ⱼ and ∀ d′ⱼ≦dⱼ,

ƒⱼ(vⱼ, d′ⱼ)≦ƒⱼ(vⱼ, dⱼ) (27)

By definition of ƒⱼ, for ƒⱼ (vⱼ′, d′ⱼ)=1, computing job j is completed before the true deadline dⱼ.

According to an example embodiment, an allocation algorithm of the FBR mechanism may be based on the linear program (LP) as discussed above. As discussed above, FBR schedules computing jobs that are fully allocated in accordance with the optimal fractional solution of (LP). More formally, given a bid vector b=(b₁, b₂, . . . , bₙ) of deadline valuation functions, a basic optimal fractional solution y* of (LP) may be determined. The resources that were allocated to computing jobs that were not completed according to y* may then be released. According to an example embodiment, the optimal fractional solution is basic, in order to increase the number of fully allocated computing jobs.

As discussed below, an example pricing technique may be used by FBR, providing a truthful mechanism. As discussed above, the allocation algorithm completes scheduled computing jobs by their reported deadline (in accordance with example transformations discussed above).

According to an example embodiment, the FBR technique may set payments pⱼ (b) according to Equation (26). Since ƒⱼ (v′ⱼ, dⱼ) is a binary function and monotonically nondecreasing in v′ⱼ, then it is a step function.

The payments charged from each allocated user according to Equation (26) is a minimal bid value for assurance that computing job j may be allocated.

According to example embodiments, pⱼ may be generated via a binary search technique or a randomized sampling technique, as discussed further below.

According to an example embodiment, a binary search may be performed to search for the minimal point where ƒⱼ returns 1 in [0, v′ⱼ], where is the bid value reported by user j. Since the searched domain is continuous, the search may be stopped when a threshold assurance value is reached.

According to an example embodiment, a randomized sampling technique may be used to fix the bids of all users but j. A new bid value s ∈ [0, v′ⱼ] may be drawn and ƒⱼ (s, dⱼ) may be calculated. If j is not allocated, the user may be charged v′ⱼ, otherwise, 0. The expected payment that is charged from user j is pⱼ (b). This procedure may be repeated multiple times and the user may be charged the average payment.

According to an example embodiment, a greedy algorithm may be used to traverse the time slots in ascending order and “fill” each time slot t by allocating resources to uncompleted computing jobs that are available (t≦dⱼ), ordered by

$$\frac{{v}_{j}}{{D}_{j}}$$

in descending order. After filling all of the time slots, any computing job which was not fully allocated may be removed.

Experimental results have indicated that mechanisms that incorporate user valuations (such as FBR and Greedy) may become relatively profitable, even when compared to fixed price mechanisms, which in practice do not guarantee user truthfulness. Thus, techniques discussed herein may be utilized for profit maximization purposes, as well as efficient scheduling of computing resources and computing jobs.

Example techniques discussed herein may provide an incentive compatible mechanism for scheduling batch applications in cloud computing environments. Example techniques discussed herein may provide a flexibility to allocate jobs a variable amount of resources which may be exploited for more efficient utilization, including resolving potential congestion. Example techniques discussed herein may provide an incentive for users to reports true values for completing their jobs within various due times. True reports may in turn be used to maximize the system efficiency, by employing a computationally efficient allocation mechanism.

Customer privacy and confidentiality have been ongoing considerations in data processing environments for many years. Thus, example techniques for determining computing job execution resource allocations may use data provided by users who have provided permission via one or more subscription agreements (e.g., “Terms of Service” (TOS) agreements) with associated applications or services associated with the resource allocations.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine usable or machine readable storage device (e.g., a magnetic or digital medium such as a Universal Serial Bus (USB) storage device, a tape, hard disk drive, compact disk, digital video disk (DVD), etc.) or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand alone program or as a module, component, subroutine, or other unit suitable for use in a computing environment. A computer program that might implement the techniques discussed above may be deployed to be executed on one computer or on multiple computers at one site or distributed across multiple sites and interconnected by a communication network.

Method steps may be performed by one or more programmable processors executing a computer program to perform functions by operating on input data and generating output. The one or more programmable processors may execute instructions in parallel, and/or may be arranged in a distributed configuration for distributed processing. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of such back end, middleware, or front end components. Components may be interconnected by any form or medium of digital data communication, e.g., a communication network. Examples of communication networks include a local area network (LAN) and a wide area network (WAN), e.g., the Internet.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method comprising:
obtaining a plurality of requests for execution of computing jobs on one or more devices that include a plurality of computing resources, the one or more devices configured to flexibly allocate the plurality of computing resources, each of the computing jobs including job completion values representing a worth to a respective user that is associated with execution completion times of each respective computing job; and
scheduling the computing resources based on the job completion values associated with each respective computing job.

2. The method of claim 1, further comprising:
determining payment amounts for charges to respective users associated with computing jobs for which the computing resources are allocated, based on the scheduling, based on incentivizing the respective users to submit true values associated with the respective job completion values.

3. The method of claim 1, wherein:
the computing resources include time slots that represent one or more networked servers and time intervals associated with use of the one or more networked servers, and
each of the computing jobs include at least one job demand value indicating an amount of the computing resources associated with execution completion of each respective computing job.

4. The method of claim 1, wherein:
scheduling the computing resources includes determining a set of feasible solutions for execution processing of the computing jobs in accordance with:
maximize Σⱼ₌₁ⁿvⱼxⱼ
such that Σ_{t≦d}_{ⱼ}yⱼ(t)=Dⱼ·xⱼ ∀ j ∈ [symbol] ,
Σ_{j:t≦d}_{ⱼ}yⱼ(t)≦C ∀ t ∈ [symbol] ,
0≦yⱼ(t)≦kⱼ ∀ j ∈ [symbol] , i≦dⱼ, and
xⱼ ∈ {0,1} ∀ j ∈ [symbol] ,
wherein
n represents a count of the computing jobs with associated users,
dⱼ represents a deadline value indicating a deadline for completion of execution of computing job j,
vⱼ represents the job completion value associated with the respective computing job j, indicating a value gained by a respective user j if computing job j is completed by the deadline,
xⱼ, represents a value indicating whether computing job j is fully allocated or unallocated,
yⱼ represents an allocation of computing resources to computing job j per time interval t,
C represents a predetermined capacity count of servers,
Dⱼ represents a demand value of computing job j indicating a number of server/time interval units associated with completion of execution of computing job j,
kⱼ represents a maximal number of computing resources allowed for allocation to computing job j in a time interval unit,
J represents the n computing jobs, and
T represents a plurality of time intervals associated with respective time intervals assigned for execution of the computing jobs.

5. The method of claim 1, wherein:
scheduling the computing resources includes determining a set of feasible solutions for execution processing of the computing jobs in accordance with:
maximize Σⱼ₋₁ⁿΣₑ₌₁^{T}vⱼ(e)xⱼ_{^{e}}
such that Σ_{t≦e}yⱼ_{^{e}}(t)=Dⱼ·xⱼ ∀ j^{e} ∈ [symbol] ,
Σ_{j,e}yⱼ_{^{e}}(t)≦C ∀ t∈ [symbol] ,
Σₑ₌₁^{T}xⱼ_{^{e}}≦1 ∀u ∈ [symbol] ,
xⱼ_{^{e}} ∈ {0,1} ∀ j^{e} ∈ [symbol] , and
0≦yⱼ_{^{e}}(t)≦kⱼ ∀ j^{e} ∈ [symbol] , t ∈ [symbol]
wherein
each respective user is represented as respective subusers j¹, j² . . . , j^{T}, wherein T represents a last time interval unit associated with execution of the computing job associated with the respective user,
each respective subuser j^{e} is associated with a deadline valuation function that includes a value of Vⱼ(e) and deadline e,
n represents a count of the computing jobs with associated users,
vⱼ represents a set of job completion values associated with the respective computing job j, wherein vⱼ(t) indicates a value gained by a respective user j if computing job j is completed at time t,
xⱼ_{^{e}} represents a value indicating whether computing job j is fully allocated or unallocated with respect to a corresponding subuser j^{e},
yⱼ^{ₑ} represents an allocation of computing resources to computing job j per time interval t with respect to a corresponding subuser j^{e},
C represents a predetermined capacity count of servers,
Dⱼ represents a demand value of computing job j indicating a number of server/time interval units associated with completion of execution of job j,
kⱼ represents a maximal number of computing resources allowed for allocation to computing job j in a time interval unit,
J represents the n computing jobs, and
T represents a plurality of time intervals associated with respective time intervals assigned for execution of the computing jobs.

6. The method of claim 1, wherein:
scheduling the computing resources includes:
determining a feasible solution for execution processing of the computing jobs, and
initiating a conversion of the feasible solution into a corresponding value-equivalent solution, wherein allocations of the computing resources, per time interval, to the computing jobs that are associated with the corresponding feasible solution, correspond to monotonically non-decreasing functions.

7. A method comprising:
obtaining a plurality of job objects, each of the job objects including a job valuation function representing a worth to a respective user that is associated with execution completion times of respective computing jobs that are associated with each respective job object;
determining an optimal fractional solution associated with a relaxed linear program (LP) for scheduling computing resources for execution of the computing jobs associated with each respective job object, based on a bounded scheduling problem based on maximizing an objective that is based on the respective job valuation functions;
determining a decomposition of the optimal fractional solution that includes a plurality of solutions, each solution determining an allocation of the computing resources; and
scheduling the computing resources based on the decomposition.

8. The method of claim 7, wherein:
determining the optimal fractional solution includes determining the optimal fractional solution in accordance with:
maximize Σⱼ₌₁ⁿΣₑ₌₁^{T}vⱼ(e)xⱼ_{^{e}}
such that Σ_{t≦e}yⱼ_{^{e}}(t)=Dⱼ·xⱼ ∀ j^{e} ∈ [symbol] ,
Σ_{j,e}yⱼ_{^{e}}(t)≦C ∀ t ∈ [symbol] ,
Σₑ₌₁^{T}xⱼ_{^{e}}≦1 ∀j ∈ [symbol] ,
0≦xⱼ_{^{e}} ∀ j^{e} ∈ [symbol] ,
0≦yⱼ_{^{e}}(t)≦kⱼ ∀ j^{e} ∈ [symbol] , t ∈ [symbol] , and
yⱼ_{^{e}}(t)≦kⱼxⱼ_{^{e}} ∀j^{e} ∈ [symbol] , t≦dⱼ,
wherein
each respective user is represented as respective subusers j ¹, j² . . . , j^{T}, wherein T represents a last time interval unit time associated with execution of the computing job associated with the respective user,
each respective subuser j^{e} is associated with a deadline valuation function that includes a value of vⱼ(e) and deadline e,
n represents a count of the computing jobs with associated users,
vⱼ represents a set of job completion values associated with the respective computing job j, wherein vⱼ (t) indicates a value gained by a respective user j if computing job j is completed at time t,
xⱼ_{^{e}} represents a value indicating whether computing job j is fully allocated or unallocated with respect to a corresponding subuser j^{e},
yⱼ_{^{e}} represents an allocation of computing resources to computing job j per time interval t with respect to a corresponding subuser j^{e},
C represents a predetermined capacity count of servers,
kⱼ represents a parallelism value indicating a measure of parallelism potential associated with execution of the corresponding computing job j,
Dⱼ represents a demand value of computing job j indicating a number of server/time interval units associated with completion of execution of computing job j,
J represents the n computing jobs, and
T represents a plurality of time intervals associated with respective time intervals assigned for execution of the computing jobs.

9. The method of claim 7, further comprising:
initiating a conversion of the optimal fractional solution into a corresponding value-equivalent solution, wherein allocations of the computing resources, per time interval, to the computing jobs that are associated with the optimal fractional solution correspond to monotonically non-decreasing functions.

10. The method of claim 9, wherein:
determining the decomposition of the optimal fractional solution includes determining a decomposition of the corresponding value-equivalent solution that includes a plurality of solutions, each solution determining an allocation of the computing resources.

11. The method of claim 10, further comprising:
selecting at least one of the plurality of solutions based on a random drawing, wherein:
scheduling the computing resources includes scheduling the computing resources based on the selected solution.

12. The method of claim 7, further comprising:
determining payment amounts for charges to respective users associated with computing jobs for which the computing resources are allocated, based on the scheduling.

13. The method of claim 12, wherein:
determining the payment amounts includes determining the payment amounts in accordance with:
pⱼ(b)=OPT*(b₋ⱼ)−(OPT*(b)−vⱼ(OPT*(b))),
wherein
pⱼ(b) represents a payment amount associated with a user j,
b represents a bid vector (b₁, . . . , bₙ) corresponding to bid valuation functions bⱼ obtained from respective users j,
OPT*(b) represents an optimal fractional social welfare value associated with b,
vⱼ(OPT*(b)) represents a value gained by user j in OPT*(b), and
OPT*(b₋ⱼ) represents an optimal fractional solution without user j participating.

14. The method of claim 13, wherein:
determining the payment amounts includes determining the payment amounts in accordance with:
$$\frac{{p}_{j} ( b )}{α \cdot {x}_{j}^{*}} ,$$
wherein xⱼ* represents a completed fraction of a computing job j associated with user j in determination of OPT*(b), and
α represents an approximation factor constant.

15. A computer program product tangibly embodied on a computer-readable storage medium and including executable code that causes at least one data processing apparatus to:
obtain a plurality of job objects, each of the job objects including a job deadline valuation function representing a worth to a respective user that is associated with execution completion times of respective computing jobs associated with each respective job object;
determine a basic optimal fractional solution associated with a relaxed linear program (LP) for scheduling computing resources for execution of the respective computing jobs associated with each respective job object, based on a bounded scheduling problem based on maximizing an objective that is based on the deadline valuation functions;
release a portion of the scheduled computing resources that is associated with a set of the job objects that are associated with respective resource allocations that are insufficient for completion of execution of computing jobs associated with the set of job objects, after determining a first modification of the basic optimal fractional solution; and
allocate the released portion to a group of the job objects that are associated with computing jobs that receive computing resources sufficient for completion of execution, in accordance with the determined basic optimal fractional solution.

16. The computer program product of claim 15, wherein the executable code is configured to cause the at least one data processing apparatus to:
determine the basic optimal fractional solution in accordance with:
maximize Σⱼ₌₁ⁿvⱼxⱼ
such that Σ_{t≦d}_{ⱼ}yⱼ(t)=Dⱼ·xⱼ ∀ j ∈ [symbol] ,
Σ_{j:t≦d}_{ⱼ}yⱼ(t)≦C ∀ t ∈ [symbol] ,
0≦yⱼ(t) ∀ j ∈ [symbol] , t≦dⱼ,
0≦xⱼ≦1 ∀0 j ∈ [symbol] , and
yⱼ(t)≦kⱼxⱼ ∀ j ∈ [symbol] , t≦dⱼ,
wherein
n represents a count of the computing jobs with associated users,
dⱼ represents a deadline value indicating a deadline for completion of execution of computing job j,
vⱼ represents a job completion value associated with the respective computing job j, indicating a value gained by a respective user j if computing job j is completed by the deadline,
xⱼ, represents a value indicating whether computing job j is fully allocated or unallocated,
yⱼ represents an allocation of computing resources to computing job j per time interval t,
C represents a predetermined capacity count of servers,
Dⱼ represents a demand value of computing job j indicating a number of server/time interval units associated with completion of execution of computing job j,
kⱼ represents a parallelism value indicating a measure of parallelism potential associated with execution of the corresponding computing job j,
J represents the n computing jobs, and
T represents a plurality of time intervals associated with respective time intervals assigned for execution of the computing jobs.

17. The computer program product of claim 16, wherein the executable code is configured to cause the at least one data processing apparatus to:
initiate a conversion of the basic optimal fractional solution into a corresponding value-equivalent solution, wherein allocations of the computing resources, per time interval, to the computing jobs that are associated with the basic optimal fractional solution correspond to monotonically non-decreasing functions, wherein each respective computing job completes execution by the corresponding execution completion deadline dⱼ associated with the respective computing job.

18. The computer program product of claim 15, wherein the executable code is configured to cause the at least one data processing apparatus to:
determine payment amounts for charges to respective users associated with computing jobs for which the computing resources are allocated, in accordance with:
pⱼ(b)=v′ⱼƒⱼ(v′ⱼ, d′ⱼ)−∫₀^{v′}^{ⱼ}ƒⱼ(s, d′ⱼ)ds,
wherein
b represents a bid associated with a user j,
ƒⱼ represents a binary and value-monotonic job allocation function associated with the user j,
dⱼ′ represents a corresponding due time declared by the user j for the completion of the execution processing, and
vⱼ′ represents a job completion value declared by a respective user j, indicating a value gained by the user j if computing job j is completed by a deadline.

19. The computer program product of claim 18, wherein the executable code is configured to cause the at least one data processing apparatus to:
determine payment amounts for charges to respective users associated with computing jobs for which the computing resources are allocated, based on:
selecting a value
s ∈ [0, vⱼ′],
based on a random drawing, for each user j that receives allocated computing resources sufficient for completion of execution; and
determining the payment amount based on a value of the value-monotonic job allocation function.

20. The computer program product of claim 18, wherein the executable code is configured to cause the at least one data processing apparatus to:
determine payment amounts for charges to respective users associated with computing jobs for which the computing resources are allocated, based on a result of a binary search over a range of [0, v′ⱼ], the binary search based on the value-monotonic job allocation function.
